(19) United States
(12) Patent Application Publication
(10) Pub. No.: US 2026/0084983 A1
(43) Pub. Date: Mar. 26, 2026

(54) A Tunable Apparatus for the Removal of Moisture from a Moisture-Containing Media

(71) Applicant: change:WATER Labs, Inc., Cambridge, MA (US)

(72) Inventors: Diana YOUSEF-MARTINEK, Cambridge, MA (US); Huda ELASAAD, Cambridge, MA (US); Andrew OLLERHEAD, Cambridge, MA (US); Ricci LACENTRA, Cambridge, MA (US); Hayley WALKER, Cambridge, MA (US); Yashik Chandrashekar GABBALADKA, Cambridge, MA (US); Ujjawal Yeshpal GAUTAM, Cambridge, MA (US); Michael MARTIN, Cambridge, MA (US); James SPENCE, Cambridge, MA (US); Amit GANDHI, Cambridge, MA (US); Joshua MALDONADO, Cambridge, MA (US)

(21) Appl. No.: 19/109,835

(22) PCT Filed: Sep. 13, 2023
(86) PCT No.: PCT/US2023/074053

§ 371 Date: Mar. 7, 2025

Related U.S. Application Data
(60) Provisional application No. 63/406,485, filed on Sep. 14, 2022.

(51) Int. Cl. C02F 1/00; A47K 11/02; B01D 61/36; C02F 1/44; C02F 103/00

(52) U.S. Cl. CPC C02F 1/008; B01D 61/362; B01D 61/366; C02F 1/448; A47K 11/02; B01D 2313/701; B01D 2313/702; B01D 2313/903; C02F 2103/005; C02F 2209/006; C02F 2209/008; C02F 2209/02; C02F 2209/42

(57) ABSTRACT

Embodiments of an apparatus and method for the removal of moisture or liquid from a moisture-containing media include an evaporative layer, a containment structure with an internal atmosphere at least partially separated from an external atmosphere, a CPU, an energy source, a tunable output element, a wicking layer and an input element operably connected to the CPU and/or energy source. A method includes collecting a moisture-containing media in a containment structure; removing moisture or liquid from the media using an evaporative layer; adjusting a tunable element based on an evaporative condition; and increasing a rate of moisture or liquid evaporation from the media and/or the evaporative layer. An apparatus includes an evaporative layer configured to contain a moisture-containing media; an air inlet; and a containment structure mounted on a mobile vehicle, wherein the air inlet directs vehicle motion generated air adjacent to or impinging with an evaporative layer.

### CROSS-REFERENCE TO RELATED APPLICATIONS

This application claims the benefit of U.S. Provisional Patent Application 63/406,485, filed Sep. 14, 2022 which is incorporated by reference herein in its entirety.

### TECHNICAL FIELDS

The relevant technical fields include evaporative processing, waste collection, and biological waste processing.

### BACKGROUND

Globally, 50% of the world's people lack safe sanitation, largely because they live in places with poor or no sewerage infrastructure or plumbing. Lack of modern toilets (or sanitary handling and removal of human waste) results in many cases of human illness and/or environmental damage from a lack of maintained municipal plumbing or the inability to install septic systems. In many regions, this is often the result of multiple combined conditions, such as a poor economy and lack of municipal funding, incompatible geological and climate/weather conditions, remoteness or, conversely, an overload in use/activity.

This is true not only for individual homes but also for public/communal toilets, such as those in schools and office buildings, camping grounds, construction sites, refugee camps/temporary settlements, events, and others. In many of these cases, the temporary use of the space makes connecting to plumbing or septic impractical, and the (currently considered “best”) alternative method is the use of portable chemical toilets in which human waste is pooled with additional odor-neutralizing chemicals until the waste can be emptied out and transported. This comes at a high economic cost and requires hefty transportation, followed by proper disposal.

The lack of appropriate home and public sanitation both have negative consequences for the individual, community and/or environment. The lack of proper residential sanitation is first and foremost a health hazard. Human feces contain pathogens which easily spread from person to-person when not effectively treated (or from person-to-plant-to-person if deposited near crops). Common results of nonexistent or ineffective municipal water sanitation include hauling waste to appropriate remote treatment facilities (costly and requiring trucks/equipment), dumping into waterways, burning waste, inelegant collection, and burial of waste (by individuals or designated community collectors), collection in a lagoon or compost pile or, in the worst cases, dumping or discarding in public/populated areas (sometimes recklessly, such as open defecation or “flying toilets”).

Poor sanitation (i.e., mismanagement of/inevitable contact with human waste, garbage and more) is responsible for 80% of all infectious disease and 4% of deaths globally. Diseases often occur from accidental ingestion of waste (a consequence of proximity) or the contamination of water or soil which, in turn, affects people who do not realize they are in contact with fecal pathogens.

This issue is compounded in high-population areas, many of which are unfortunately prime examples of areas with poor sanitation measures and heavy, rapid buildup of human waste and pollution. While children, the elderly and those with compromised immune systems are typically the most at-risk of death from poor sanitation, chronic illness nonetheless occurs and diarrhea from pathogens is an abundantly common problem which affects people of all ages and is still potentially deadly in many parts of the world.

In addition to health problems, poor sanitation can drastically affect a person's quality of life or social prospects. In many regions, this means a person must carry the waste from their household nightly/regularly to remote areas to be buried away from communities, far enough that it will not contaminate waterways. Outside of the home, in schools, the lack of modern sanitation requires students to use distant and/or heavily communal toilets when at school, which puts students (particularly women and girls) at risk of being attacked while in a vulnerable state. These attacks are not uncommon and, as a result, students routinely avoid using the toilet by holding in their waste while at school (sacrificing comfort and health) or staying home from school (sacrificing their education). In refugee camps and other situations, a more desperate scenario exists where a person's only options are using communal toilets with the same risks, or relieving themselves in their dwelling/away from the toilets.

In many areas, there exist alternatives (often government or NGO aid or intervention) devoted to removing and treating waste from areas with poor sanitation profiles. Alternatives typically involve picking up waste in a truck or cart and transporting it to a remote area where it can be composted (requires land/labor and quite some time before safe), burned or desiccated in ovens (space and energy requirements), or treated in a biodigester/bioreactor.

However, these alternative methods are associated with significantly increased cost (higher than what most people pay to have toilets in their home in compatible areas) and, while typically paid for or subsidized by governments, NGOs or other forms of aid/charity. Additionally, these methods require a network of manpower and funding to operate.

Human waste is primarily comprised of water; approximately 99% in urine and 75-85% in feces. This water substantially contributes to the overall weight and volume of human waste, each of which in turn contribute to the transportation costs and logistical challenges for handling and transporting the waste. Therefore, a significant logistical cost savings may be realized by separating and/or removing water or other liquids from a collected waste.

Removing liquid water or moisture from a waste may be performed in remote systems via the general process of evaporation. Additionally, moisture may be removed from a system using the process of pervaporation in combination with or in place of evaporation. To maximize the amount of moisture removed from a waste and minimize the time required to remove said moisture, an evaporative system must be optimized. However, creating such an optimized system presents challenges as both evaporation and pervaporation are affected by numerous, dynamic conditions including weather, pressure, temperature, location, time, and condition of the waste. A static evaporative system inherently cannot be fully optimized against a dynamic range of conditions. Therefore, evaporative and/or pervaporative performance of a static system diminishes when dynamic conditions move outside the range the static system is optimized against. The present disclosure teaches apparatuses, methods, and systems to address these challenges.

### SUMMARY

This Summary is provided to introduce a selection of concepts in simplified, which is further described below in the Detailed Description. This Summary is not intended to identify key features or essential features of the claimed subject matter, nor is it intended to be used as an aid in determining the scope of the claimed subject.

Embodiments of an apparatus may include a containment structure, at least one evaporative layer, at least one output element and/or a communication element, a CPU, and an energy source.

Embodiments of the apparatus may include a wicking layer, either in contact or not in contact with an evaporative layer.

Embodiments of the apparatus may include at least one input element in operable connection with the CPU and/or an energy source.

An input element may comprise one or a combination of a digital sensor, an analog sensor, or a sensor directly or indirectly connected to the at least one energy source.

An input element may comprise a mechanical device.

An input element may comprise one or a combination of a remote command terminal or a remote independent data source.

An input element may be configured to measure a temperature of a moisture-containing media.

An input element may comprise one or a combination of a thermometer, a barometer, a hygrometer, an anemometer, an electrochemical or gas sensor, an infrared sensor, an ultraviolet sensor or any other atmospheric measurement sensor.

An input element may be configured to measure one or a combination of an osmolarity, osmolality, or chemical and/or biological constituents of the moisture-containing media.

An input element may be a total dissolved solids sensor, an ion sensor, a conductivity sensor, a pH sensor, a colorimetric sensor, a salinity sensor, an electrochemical sensor, or any sensor capable of measuring osmolarity and/or osmolality.

An input element may be configured to detect a presence of a bacteria, virus, fungus, microorganism and/or other biological materials and/or indicators.

An input element may be a load cell configured to measure a weight of a moisture-containing media.

An input element may be configured to detect a presence of a user of the apparatus.

An input element may be one or a combination of a laser sensor, an ultraviolet sensor, a photoelectrical sensor, a motion sensor, a proximity sensor, a sensor to detect sound, a pressure sensor, a touch or contact sensor, an infrared sensor, an ultrasonic sensor, or any other sensor capable of detecting a user presence.

An input element may be configured to measure a distance of a moisture-containing media relative to a location or reference point within the apparatus.

An input element may be a laser sensor, an infrared sensor, an ultraviolet sensor, an ultrasonic sensor, a photoelectrical sensor or any other sensor capable of measuring distance.

A vent may be configured to provide an airflow having an optimized velocity relative to an at least one evaporative layer.

An input element may be a float sensor configured to measure a level of a collected moisture-containing media.

An input element may be configured to measure a moisture content of the moisture-containing media and/or least one evaporative layer.

The CPU may be configured to control the at least one output element based on an input from the at least one input element.

The CPU may be configured to communicate messages, commands or data to a remote terminal and/or receive messages, commands or data from a remote terminal based on a value received and/or measurement collected from an at least one input element.

An output element may be configured to affect a rate of evaporation of moisture from the moisture-containing media.

An output element may be a fan, a heater, a vent, or an element configured to adjust a contact surface area between the at least one evaporative layer and/or wicking layer with the moisture-containing media.

An output element may be a heater configured to operate in contact with the moisture-containing media and/or an internal containment structure or collection vessel.

An output element may be a vent connecting internal and external atmospheres.

An output element may be an adjustable airflow baffle configured to direct an airflow relative to the at least one evaporative layer. In an embodiment, the baffle may also be static.

An evaporative layer may be configured to remove moisture from the moisture-containing media at least in part by pervaporation.

An evaporative layer may comprise one or a combination of a hydrophilic material, a hydrophobic material, a non-hydrophobic material, a wicking and/or breathable material, an oleophobic material, or a hygroscopic material.

Embodiments of the apparatus may include an indicator element operably connected to the CPU and/or the at least one energy source, wherein the CPU is configured to activate the indicator element.

An indicator element may be one or a combination of a light, a speaker, a screen, or an electrical and/or mechanical indicia.

The CPU may be configured to activate the indicator element when a sensor measurement or received data input or command is determined to be within a calibration value range.

Embodiments of the apparatus may include a switch in circuit with the energy source, wherein the CPU is configured to selectively connect and/or disconnect the energy source from operable connection with the apparatus by controlling the switch.

Embodiments of the apparatus may include more than one energy source in operable connection with the CPU and in circuit with a switch. The CPU may be configured to activate the switch to connect and/or disconnect an energy source.

Embodiments of the apparatus may include an external sensor operably connected to the CPU and configured to measure a condition of the external atmosphere, wherein the CPU is configured to control the at least one output element based on measurements and/or data from the input element and/or the external sensor.

Embodiments of the apparatus may include a first and second tunable fan.

The first and second fans may be configured to create airflows of different, parallel, perpendicular, and opposite flow directions.

The first and second tunable fans may be positioned in connection to a corresponding first and second fan aperture formed by the containment structure.

The containment structure may further form a circulation aperture adjacent to the first and second fan aperture and coplanar with the first and second fan apertures.

The containment structure may form a first and second headspace volume each adjacent to an evaporative layer, the first headspace volume being larger than the second headspace volume.

The communication element may be configured to transmit and/or receive data via at least one of wifi, Bluetooth, radio, cellular wireless network, global positioning system, or any other wireless connection.

The containment structure may include a collection opening panel forming and orifice for introducing moisture-containing media, and further include a lid configured to rest in a rest position that prevents moisture-containing media from passing through the collection opening panel, be oriented in an open position that allows moisture-containing media to pass through the collection opening panel when a mechanical and/or electrical force is applied to the lid, and return to the rest position when a mechanical and/or electrical force is removed from the lid.

The lid may further include a liquid diverter configured to nest within a profile of the lid and allow liquid to be introduced into the containment structure, and remain stationary relative to the apparatus when the lid is oriented in an open position.

The containment structure may include at least one removable access panel.

Embodiments of the apparatus may include a switch that is engaged by, in contact with and/or connected to the at least one removable access panel, wherein any energy source is removed from operable connection with the apparatus when the at least one removable access panel is removed from the apparatus.

Embodiments of the apparatus may further include a seat configured to support a user weight.

Embodiments of the apparatus may include an electrical component and/or system operably connected to the CPU and/or the at least one energy source, wherein the electrical component or system is one or a combination of a local and/or cloud-based memory, an application programming interface, a user interface, a display, a graphics processing unit, a security module, a battery, a capacitor, an inverter, or a relay.

Embodiments of the apparatus may include a liquid media receptacle configured to collect and/or divert liquid media.

Embodiments of the apparatus may include a user structure configured to at least partially conceal a user when the user deposits moisture-containing media into the apparatus, and a user door attached to the user structure, wherein the output element is a locking mechanism attached to the door and/or user structure.

A method for of increasing a rate of evaporation of moisture from a moisture-containing media comprising collecting a moisture-containing media in a containment structure; removing moisture from the moisture-containing media using an evaporative layer; adjusting a tunable element based on the evaporative condition; and increasing a rate of moisture evaporation from the moisture-containing media and/or the evaporative layer.

The method may further include determining an evaporative condition within and/or external to the containment structure.

The method may further include determining a condition of each of a plurality of energy sources; selecting an optimized energy source supply configuration; and engaging and/or disengaging one or a plurality of the energy sources according to the optimized energy source supply configuration.

The method may further include calculating a difference between a measured evaporative condition and a target evaporative condition, wherein adjusting the tunable element is based on the calculated difference.

In a method, the at least one evaporative layer may comprise one or a combination of a hydrophilic material, a hydrophobic material, a non-hydrophobic material, a wicking and/or breathable material, an oleophobic material, or a hygroscopic material.

In a method, the evaporative condition may comprise at least one of an air temperature, an air humidity, an air pressure, an air speed, a collected media moisture content, a collected media temperature, an evaporative layer moisture content, or a collected media osmolarity.

In a method, the evaporative condition may be a relationship between osmolarity of the collected media, temperature of the collected media, and/or humidity of an atmosphere in the containment structure.

In a method, the step of adjusting a tunable element may comprise increasing or decreasing at least one fan speed to generate an airflow between 85 cubic feet per minute and 1000 cubic feet per minute.

In a method, the step of determining an evaporative condition may comprise querying a remote database for environmental data specific to a geographic location of the containment structure. In a method, evaporative condition may comprise a temperature differential between collected moisture-containing media and an internal atmosphere inside the containment structure.

In a method, the step of adjusting a tunable element may comprise at least one of changing a quantity of activated fans of a plurality of fans, adjusting a vent opening, adjusting a heater output, or adjusting a heater orientation.

A method of removing moisture from a moisture-containing media includes collecting a moisture-containing media into contact with an evaporative layer; providing an airflow adjacent to a side of the evaporative layer not in contact with the collected media; providing an airflow adjacent to a surface of the collected media; and removing moisture from the collected media.

The method may include the step of drawing moisture away from the collected media and into an airflow pathway using a wicking layer not connected to the evaporative layer.

Embodiments of the apparatus may be configured to be mounted to a vehicle, and utilize air currents generated by the moving vehicle to improve evaporation and/or pervaporation from a evaporative layer containing a moisture-containing media.

Embodiments of the apparatus may be a toilet.

### BRIEF DESCRIPTION OF THE FIGURES

The foregoing summary, as well as the following detailed descriptions, will be better understood when read in conjunction with the appended drawings For the purpose of illustration, certain examples of the present description are shown in the drawings. It should be understood, however, that the invention is not limited to the precise arrangements, configurations, and instrumentalities shown. The accompanying drawings, which are incorporated in and constitute a part of this specification, illustrate an implementation of systems, apparatuses, and methods consistent with the present description and, together with the description, serve to explain advantages and principles consistent with selected embodiments of the invention.

FIG. 1 is a head-on view of a non-limiting apparatus embodiment showing various structures, elements, and configurations including evaporative layers, wicking layers, a containment structure, a CPU, pipework, a communication element, an energy source, a load cell, and an interlock switch.

FIG. 2 is an angled view of a non-limiting apparatus embodiment showing various structures, elements, and configurations including a lid, liquid media receptacle, and indicator element.

FIG. 3A is a head-on view of a non-limiting apparatus embodiment showing various structures, elements, and configurations, including a heater and float probe.

FIG. 3B is an alternate perspective of the heater and float probe of FIG. 3A.

FIG. 4A is an air flow model graphic showing non-limiting examples of an embodiment.

FIG. 4B is an air flow model graphic showing non-limiting examples of an embodiment as viewed from above.

FIG. 5 is an angled view of a non-limiting apparatus embodiment showing various structures, elements, and configurations, including a baffle, a motor, fans, and apertures.

FIG. 6 is a non-limiting electric circuit diagram including of electrical component and conductivity aspects of an embodiment.

FIG. 7A is an angled view of a non-limiting embodiment including a headspace with tunable capabilities.

FIG. 7B is an air flow model graphic showing non-limiting examples of an embodiment including a headspace.

FIG. 8A is a non-limiting embodiment of a lid with self-closing functionality and nested liquid diverter, in a closed state.

FIG. 8B is a view of the embodiment of FIG. 8A in an intermediate state.

FIG. 8C is a view of the embodiment of FIG. 8A in an open state.

FIG. 9 is a non-limiting example of a containment structure.

FIG. 10A is a head-on view of a non-limiting example of a user structure.

FIG. 10B is a top-down view of the user structure of FIG. 10A.

FIG. 11 is a non-limiting apparatus embodiment.

FIG. 12 is a concept schematic of a non-limiting logic group.

FIG. 13 is a flow diagram of a non-limiting method.

FIG. 14 is a flow diagram of another non-limiting method.

FIG. 15 is a flow diagram of another non-limiting method.

FIG. 16 is a flow diagram of another non-limiting method.

FIG. 17 is a flow diagram of another non-limiting method.

FIG. 18 is a flow diagram of another non-limiting method.

FIG. 19 is a flow diagram of a non-limiting concept process.

FIG. 20 is a flow diagram of another non-limiting concept process.

FIG. 21 is a flow diagram of another non-limiting concept process.

FIG. 22A is a non-limiting embodiment of a wicking layer with a split.

FIG. 22B is a non-limiting embodiment of a series of wicking layers with a split.

FIG. 23A is a non-limiting embodiment of a condensation hood.

FIG. 23B is a non-limiting embodiment of gutters and channels of a condensation hood.

FIG. 24A is a non-limiting embodiment of a central inline fan.

FIG. 24B is a non-limiting embodiment of ducting for a central inline fan.

FIG. 25 is a non-limiting embodiment of a floatation module for a heater.

FIG. 26A is a non-limiting embodiment of a perspective view of a conductive wire array.

FIG. 26B is a non-limiting embodiment of a top view of a conductive wire array.

FIG. 27 is a non-limiting embodiment of a servicing door.

### DETAILED DESCRIPTION

The following detailed description is provided to assist the reader in gaining a comprehensive understanding of the apparatuses, methods and/or systems described herein. Accordingly, various changes, modifications, and equivalents of the apparatuses, methods and/or systems described herein will be suggested and thus apparent to those having ordinary skill in the art. Also, descriptions of well-known functions and constructions may be omitted for increased clarity and conciseness to the reader.

In addition, it is to be understood that the phraseology and terminology employed herein are for the purpose of description and should not be regarded as limiting. For example, the use of a singular term, such as, “a” is not intended as limiting of the number of items. Also the use of relational terms, such as but not limited to, “top,” “bottom,” “left,” “right,” “upper,” “lower,” “down,” “up,” “side,” are used in the description for clarity and are not intended to limit the scope of the invention or the appended claims. Further, it should be understood that any one of the features can be used separately or in combination with other features. Other systems, methods, features, and advantages of the invention will be or become apparent to one having ordinary skill in the art upon examination of the detailed description. It is intended that such additional systems, methods, features, and advantages be included within this description, be within the scope of the present invention, and be protected by the accompanying claims.

This disclosure describes embodiments of an apparatus and method to remove or reduce or separate moisture or liquid water from a moisture-containing media or wet mass such as, but not limited to, waste, sewage, wastewater or water with some impurities. It should be understood for this disclosure that moisture-containing media, media, collected media, liquid media, liquid moisture-containing media, liquid-containing media, and wet mass are synonymous and may be used interchangeably. It should be understood that the term “moisture-containing” may refer to a liquid and/or water and/or a state of including or containing a liquid or a state of including or containing water. Additionally, “moisture-containing media” may refer to a solid and/or liquid human or animal waste such as urine and fecal matter or stool. Some embodiments comprise a toilet as generally but not limitingly defined as a structure, device, and/or location configured to receive, collect, store, treat, and/or process human waste.

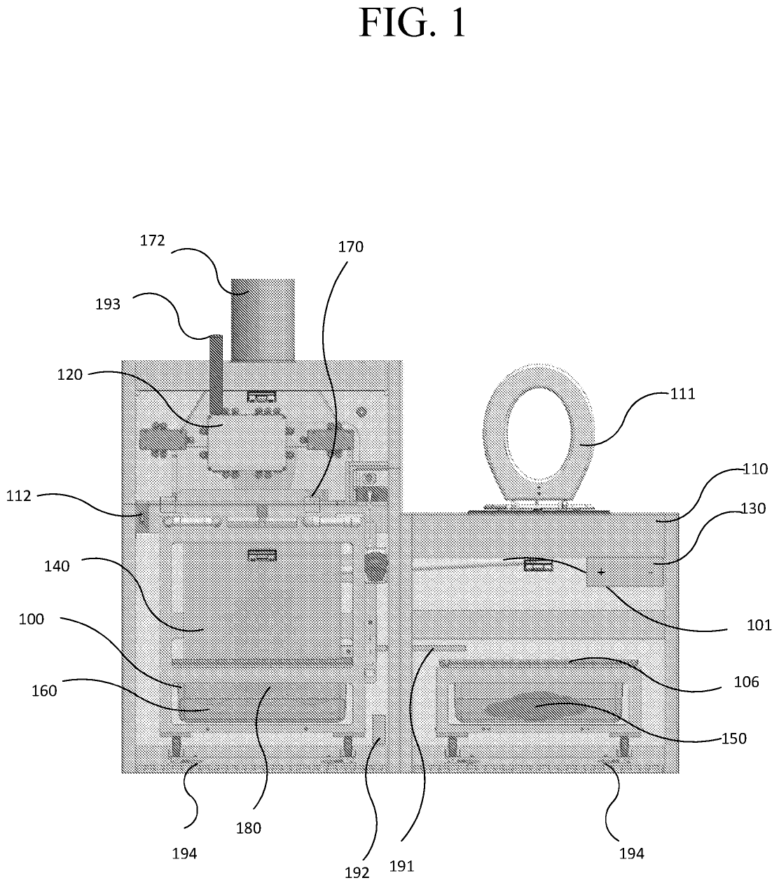

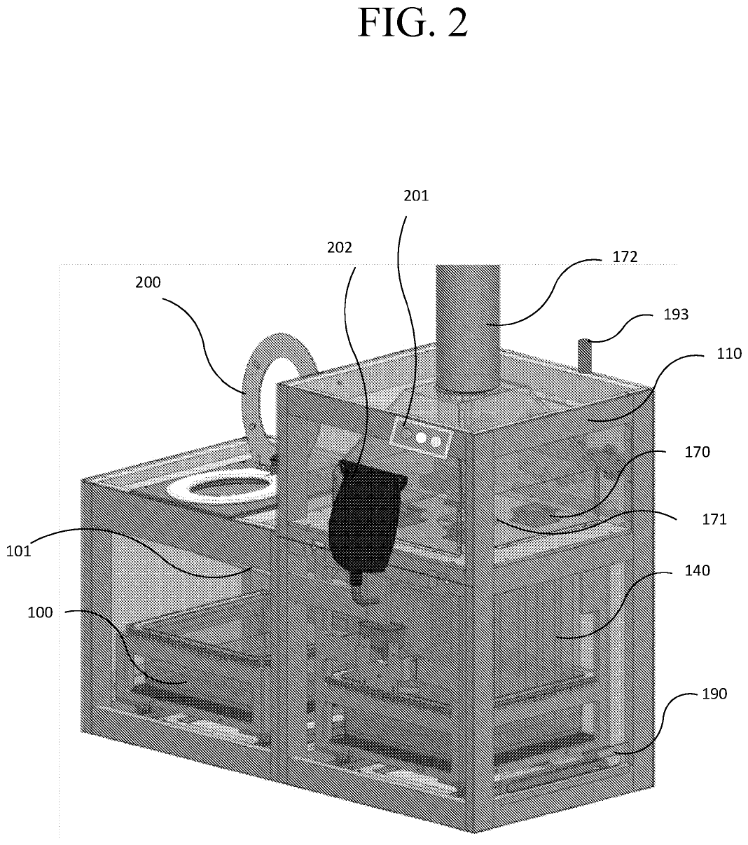

As seen in FIGS. 1-2, embodiments may leverage one or more evaporative layers 100 and/or materials in contact with a wet mass to remove moisture or liquid by evaporation and/or pervaporation. In some embodiments, the at least one evaporative layer may contain or collect a moisture-containing media, such that the media has a surface exposed to the atmosphere and in contact with the evaporative layer 100. Embodiments may also leverage one or more tunable or responsive output elements to adjust, optimize and/or communicate the function, performance, or operations. Embodiments of the apparatus may contain the wet mass and evaporative layer(s) 100 inside a containment structure 110 which is capable of at least partially separating an internal environment inside the structure from an atmosphere external to the structure. At least partial atmosphere separation may refer to the ability to either maintain independently or work cooperatively with another element to create an internal atmosphere pressure either higher or lower than the atmosphere pressure external to the containment structure 110. Additionally, partial atmosphere separation may refer to the containment structure 110 atmosphere having different temperature, humidity, or gas content than the atmosphere external to the containment structure 110. For a non-limiting example, fans 170 may evacuate air from inside the containment structure 110, thus creating a relatively low pressure atmosphere of 950 millibar thanks to the walls of the containment structure 110 preventing immediate pressure equalization with the external atmosphere of 1000 millibar. Such a pressure differential may then encourage air ingress through various openings or orifices in the containment structure. In another non-limiting example, the atmosphere inside the containment structure may be 120° F. while the external atmosphere may be 100° F., while the pressures of both atmospheres may be equal as a result of various openings or orifices in the containment structure. In some embodiments, the containment structure 110 completely isolates an internal atmosphere from an external atmosphere, such that there is no connection between the atmospheres. In some embodiments, the containment structure 110 may enclose a liquid side and a solid side. In such embodiments, urine may be collected in the liquid side and fecal matter or stool may be collected on the solid side and each side may include respective evaporative layers 100. The internal environment may be adjusted using at least a CPU 120, and an energy source 130 in various configurations of operable connection to tunable components and/or communication elements to effect one or more outcomes. Operable connection may refer to a one or a combination of a physical or wired connection, a wireless communication connection, or a remote energy connection such as by but not limited to electric and/or magnetic field. A CPU 120 may include or be connected to a controller or microcontroller, a processing unit, a computing device or data analysis element and may be enclosed by a cover or box. Effected outcomes may include but are not limited to: adjustment or optimization of evaporative performance or efficiency of moisture removal or water separation from the wet mass; optimizing power usage or switching between various available sources of energy; activating or engaging connected electrical components; activating or engaging warning elements and/or system shut-off functions; data collection or tracking, and/or communications to and/or from a remote operator or data source or data store or application programing interface.

In some embodiments, the containment structure 110 may include an insulation layer. The insulation layer may be on an inside surface or an outside surface of the containment structure 110. Non-limiting examples of insulation materials include fiberglass, mineral wool, cellulose, natural fibers, polystyrene, polyisocyanurate, polyurethane, perlite, cementitious foam, phenolic foam, insulation facings, and phase change materials. Including an insulation layer may enhance the efficacy of internal heating of the containment structure 110.

In some embodiments, the containment structure 110 may include a soundproofing layer. The soundproofing layer may be on an outside surface the containment structure 110. Non-limiting examples of sound proofing materials include acoustic membrane, open cell cavity insulation, decoupling products, acoustic flooring, acoustic panels, acoustic fabrics, acoustic foam, fiberglass, plasterboard, dense board (e.g., plywood), acoustic caulk, soundproof spray, soundproof paint, and soundproof wallpaper. Including a soundproofing layer may minimize the noise of the different components of the apparatus, such as a fan.

In some embodiments, the soundproofing layer may be adjacent to the insulation layer. In other embodiments, the soundproofing layer and the insulation layer are incorporated into one layer.

In an example embodiment, one or more wicking layers 140 may be implemented to increase the rate of moisture removal from the moisture-containing media. Wicking layers 140 may be oriented and supported in a variety of configurations.

In one non-limiting example, wicking layers 140 are suspended above and perpendicular to one or more evaporative layers using a support frame contained inside the containment structure. In such an example, wicking layers 140 may be draped over a support frame, may be secured to a support frame using clips or fasteners, or may allow a support frame to penetrate the thickness of the wicking layer 140 to therefore suspend the wicking layer 140 by the frame. The one or more wicking layers 140 may be composed of one or more hydrophobic, hydrophilic, non-hydrophobic and/or hygroscopic materials configured to transport moisture across a broader surface area. Non-limiting examples of the wicking layer material include paper, textiles and/or other natural or synthetic fibrous materials. In such an embodiment, the wicking layer 140 is at least partly in contact with a moisture-containing media during operation. The at least one wicking layer 140 may be fully or partly in contact with the at least one evaporative layer 100. In some embodiments, the wicking layer 140 extends beyond or away from the evaporative layer 100 and/or moisture-containing media to transport moisture to areas within the containment structure which may increase evaporative surface area inside the containment structure and/or improve drying rates, including but not limited to areas of high airflow, high temperature and/or low humidity. In some embodiments the wicking layer 140 may be positioned in the pathway of an airflow, such that moisture or liquid may be drawn from the media, into or onto the wicking layer 140, and placed in the pathway of the airflow, thus providing an additional vector of evaporative moisture or liquid removal.

In some embodiments, the thickness of the at least one wicking layer 140 may be varied based on operational or environmental conditions.

Liquid derived from the moisture-containing media may include dissolved and/or suspended particles, including but not limited to ions and/or microorganisms. The at least one wicking layer 140 provides a layer for moisture transport and/or distribution in which liquid or moisture may evaporate into the surrounding atmosphere, whereas dissolved and/or suspended particles are retained on the surface of the at least one wicking layer 140. In such an embodiment, the wicking layer 140 provides a surface from which particles dissolved and/or suspended in liquid may be collected.

In some embodiments, the at least one wicking layer 140 is not connected or in contact with the at least one evaporative layer 100, providing two separate surfaces from which and/or through which moisture may evaporate. In such an embodiment, the at least one wicking layer 140 is in contact with the moisture-containing media, which may be in contact with the at least one evaporative layer 100. Non-limiting embodiments may allow better tunability in relation to the media as the size or positioning of the at least one wicking layer 140 which may be tuned to enhance the contact with and/or removal of moisture. The at least one wicking layer 140 may be in the form of any structural shape or orientation such that the layer makes adequate contact with the moisture-containing media and provides a surface from which transported moisture or liquid may evaporate. Some non-limiting embodiments may allow easier serviceability, insertion, and/or construction of the evaporative and/or wicking materials.

In one example embodiment, the moisture-containing media is supported on one side by the at least one evaporative layer 100 while the at least one wicking layer 140 is suspended from above, making partial contact with the moisture-containing media. In such an embodiment, moisture or liquid from the media is absorbed into the wicking layer and transported across a broad surface area, which may be in the path of airflow to increase the rate of evaporation from the wicking layer surface. By suspending the at least one wicking layer 140 vertically, moisture or liquid may be transported to areas with increased airflow and/or decreased humidity where the rate of evaporation may be increased.

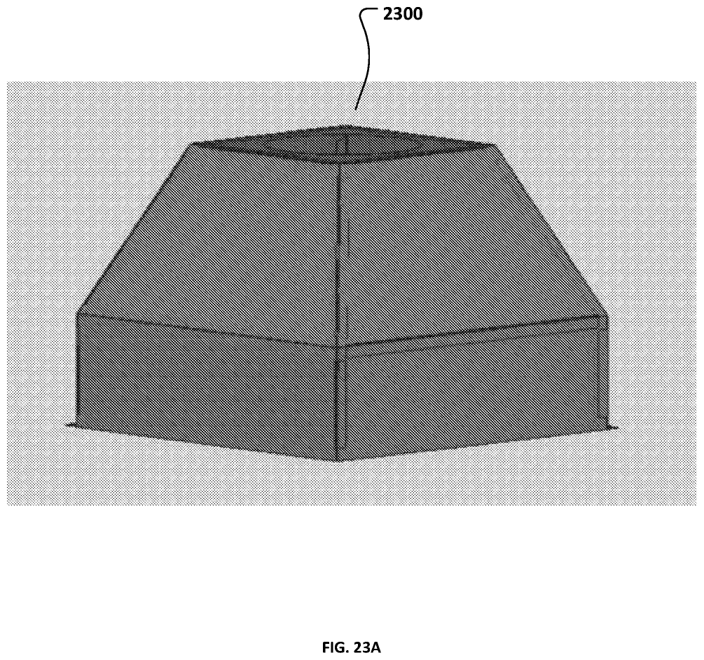

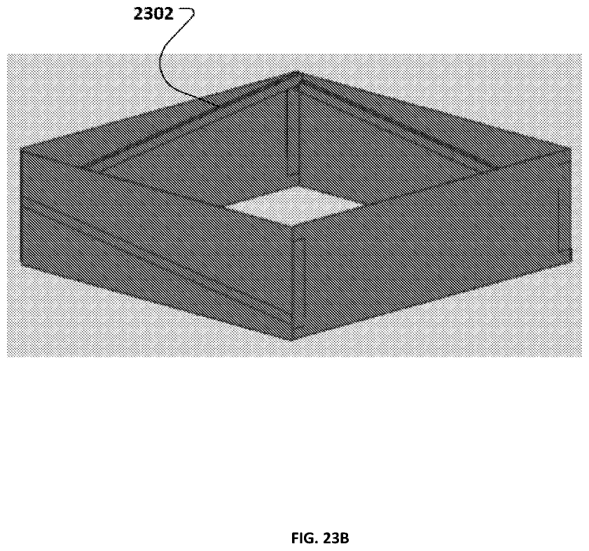

In another example embodiment, shown in FIGS. 22A-B, the at least one wicking layer 140 includes at least one split 2202. The at least one wicking layer may have at least two split flaps created by the at least one split 2202. The at least one split 2202 may be through the entire thickness of the at least one wicking layer 140 and may extend from an edge of the at least one wicking layer 140. In some embodiments, the support frame may be configured to drop the flaps in a waste collection bag in a release position. The release position may be utilized when servicing the containment structure 110.

In some embodiments, a cascading pump may be utilized to keep the flaps of the at least one wicking layer 140 wet when it is not in the rest position. In one example, an electrical pump suctions moisture-containing media collected in the evaporative layer 100 or other reservoir into a diaphragm. The pump then delivers the collected moisture-containing media from the diaphragm and along a tube to an exit port for expulsion. The exit port is oriented so that expelled moisture-containing media is applied to the flaps of the at least one wicking layer 140.

The flaps in the wicking layer allow for improved ease of servicing because the flaps drop into the waste collection bag at the rest position, preventing any of the matter remaining on the at least one wicking layer 140 from spilling onto the user or external environment. This may make the servicing process safer for the user.

In some embodiments, the at least one evaporative layer 100 may perform moisture removal from the media or wet mass, in part or in whole, by the process of pervaporation. In a preferred embodiment, the at least one evaporative layer 100 may remove moisture from the wet mass by both pervaporation through the evaporative layer and by allowing moisture or liquid evaporation directly from the surface of the wet mass being contained by and/or in contact with the evaporative layer 100. In such an embodiment, the efficiency of moisture or liquid removal from a wet mass may be increased compared with only evaporating moisture or liquid through a surface of a wet mass otherwise contained or in contact with some non-pervaporative layer.

In some embodiments, the at least one evaporative layer 100 may comprise one or a combination of a hydrophilic material, a hydrophobic material, a non-hydrophobic material, a wicking and/or breathable material, an oleophobic material, and/or a hygroscopic material. In a preferred embodiment, the at least one evaporative layer 100 may comprise a hydrophilic, pervaporative material such as one or a combination of thermoplastic elastomers (TPE), including but not limited to thermoplastic polyurethanes, thermoplastic copolyester, thermoplastic polyamides, as well as commercially available brands of TPE including but not limited to Laripur®, Desmopan®, Elastollan®, HYTREL®, PEBAX®, VESTAMID®, Engage® Santoprene®, Termoton®, Arnitel®, Solprene®, Dryflex®, Mediprene®, Kraton®, Pibiflex®, FORPRENE®, TERMOTON-V®. SOFPRENE®, and LAPRENE®, as well as other materials including but not limited to Tyvek®. In some embodiments, at least one evaporative layer 100 may be supported or suspended within the containment structure using various structures. In one non-limiting example, evaporative layers 100 are suspended in a horizontal orientation parallel to the ground using steel, wood, and/or plastic or PVC support frames 106 to form a sheet, bag or vessel, such that a moisture-containing media may be collected on and/or in the evaporative layer. In other non-limiting examples, evaporative layers 305 may be suspended or oriented in a vertical or diagonal orientation, such that the evaporative layers may direct or otherwise guide or support a wet mass. In some non-limiting examples, evaporative layers 100 and/or wicking layers 140 may be draped over support rungs so that a portion of a layer held by gravity against a support rung allows the layer to be suspended.

In some embodiments, a solid wet mass 150 and/or liquid wet mass 160 is collected or contained inside the containment structure 110, so that the wet mass is in contact with one or more above-described evaporative layers 100 or surfaces. In a non-limiting example, solid and liquid wet masses are each collected in a waste collection bag comprising an evaporative layer 100 or surface. A passive or active airflow may be directed to be in contact with or adjacent to the collected media and/or the one or more evaporative layers or surfaces. The evaporative surfaces 100 may be placed in various and/or adjustable orientations, to maximize availability and exposure of evaporative surfaces in a more compact space and to optimize or enhance evaporative efficiency of such an approach or system. The one or more evaporative layers may include one or more static or adjustable wicking layers 140 in contact with the collected wet mass and placed or oriented in such a way as to draw moisture away from the collected mass and into an airflow pathway. In some embodiments, one or more wicking layers 140 may be included as separate from an evaporative layer such that moisture is evaporated, pervaporated or drawn away from the moisture-containing media through either the wicking layer or the evaporative layer, or both. The CPU 120 may be used to determine an evaporative condition within or external to the embodiment. Non-limiting examples of evaporative conditions include an air temperature, an air humidity, an air pressure, an air speed, an air current direction, a collected media's moisture content, a collected media's temperature, an evaporative layer's moisture content, a temperature differential between collected moisture-containing media and the containment structure's internal atmosphere, or a collected media's osmolarity. Based in whole or in part on the evaporative condition, the CPU 120 may control one or more tunable components or outputs such as but not limited to a fan 170, a vent 190 connecting internal and external atmospheres, a baffle 191, an airflow diffuser such as any structure configured to diffuse, steady, or develop a laminar flow, and/or a heater 180 to affect or adjust the evaporative condition to a status more favorable to removing moisture or liquid from a collected media. In some embodiments, the CPU 120 may alternatively adjust an evaporative condition to decrease an evaporative performance in scenarios when it may be beneficial to the operation of the embodiment to decrease the rate of moisture or liquid removal from a collected media.

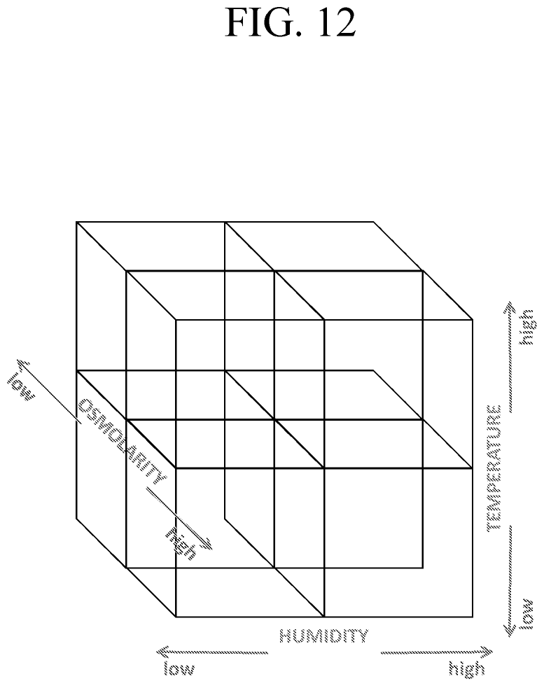

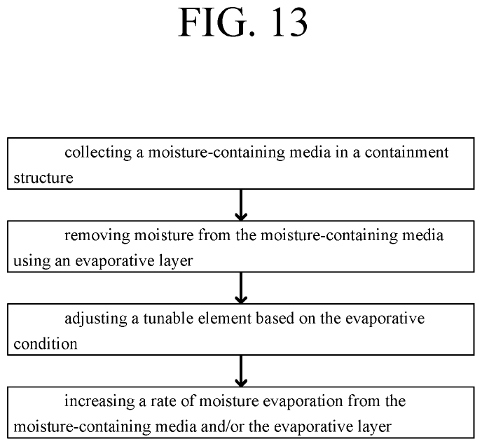

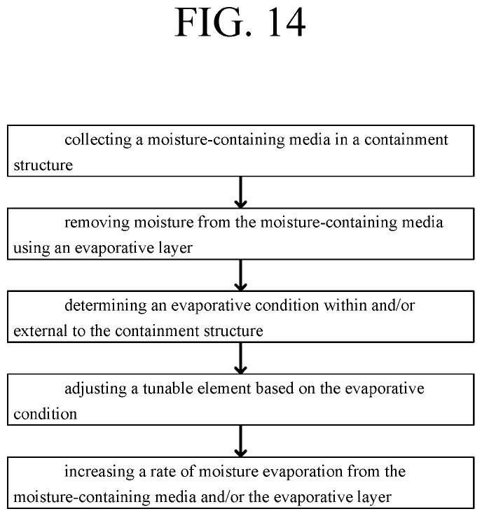

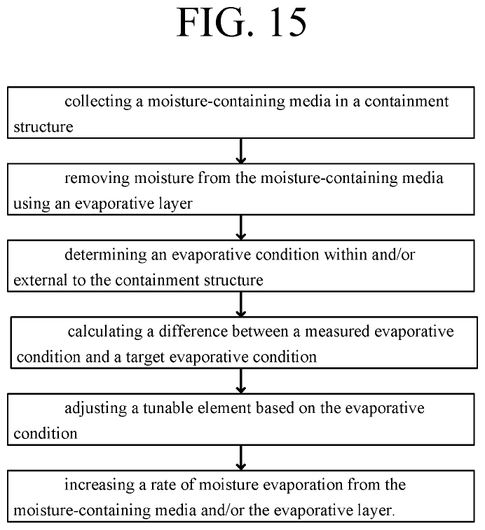

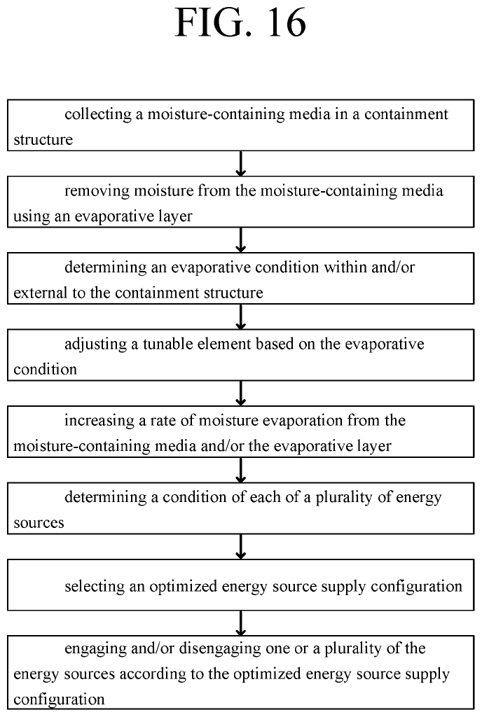

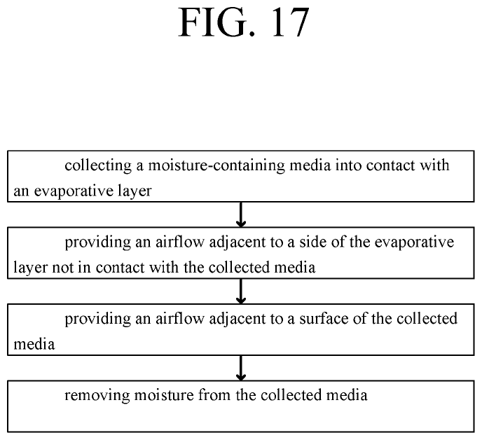

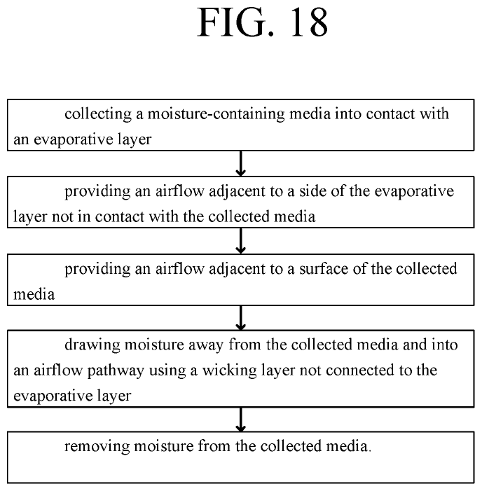

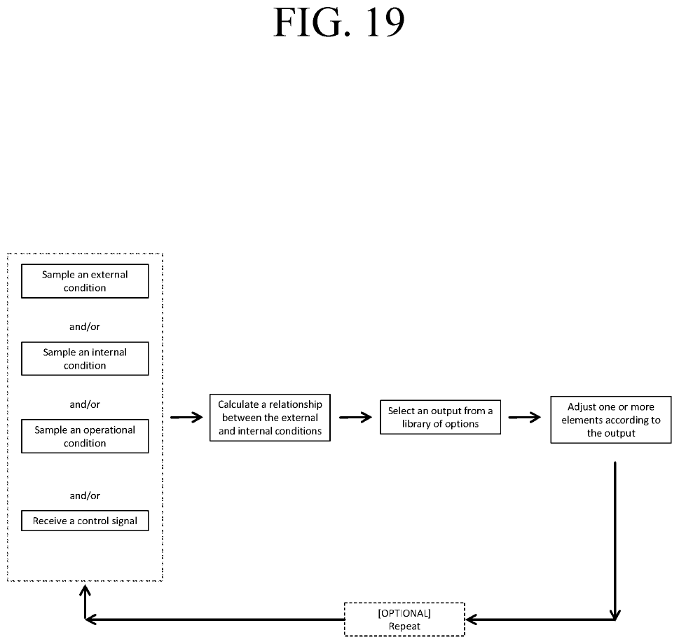

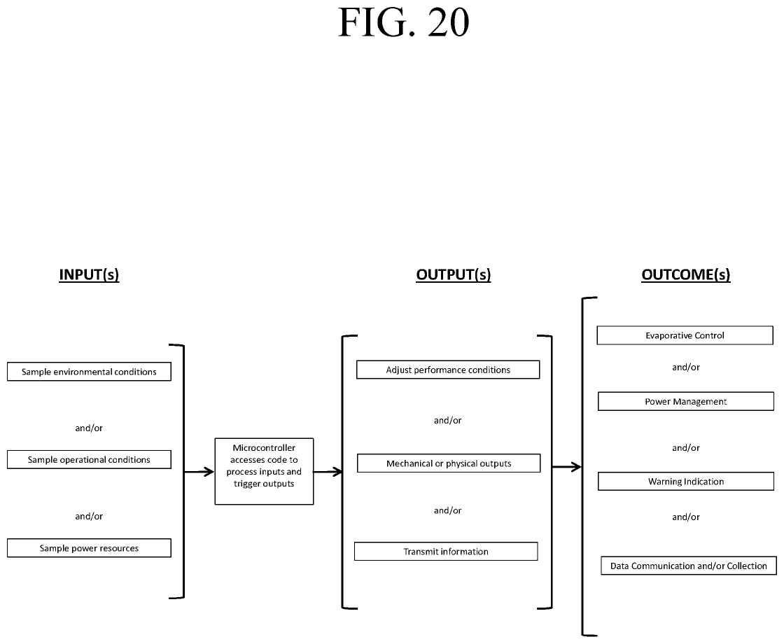

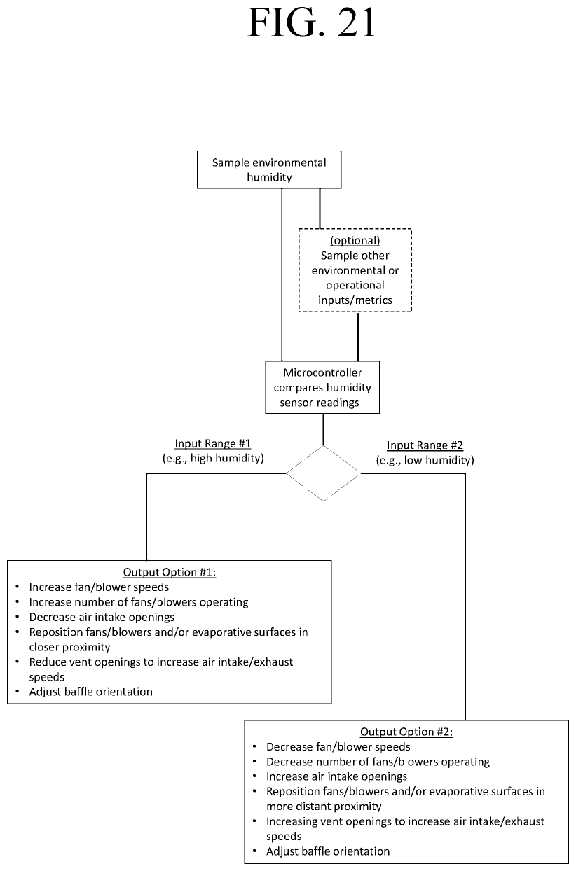

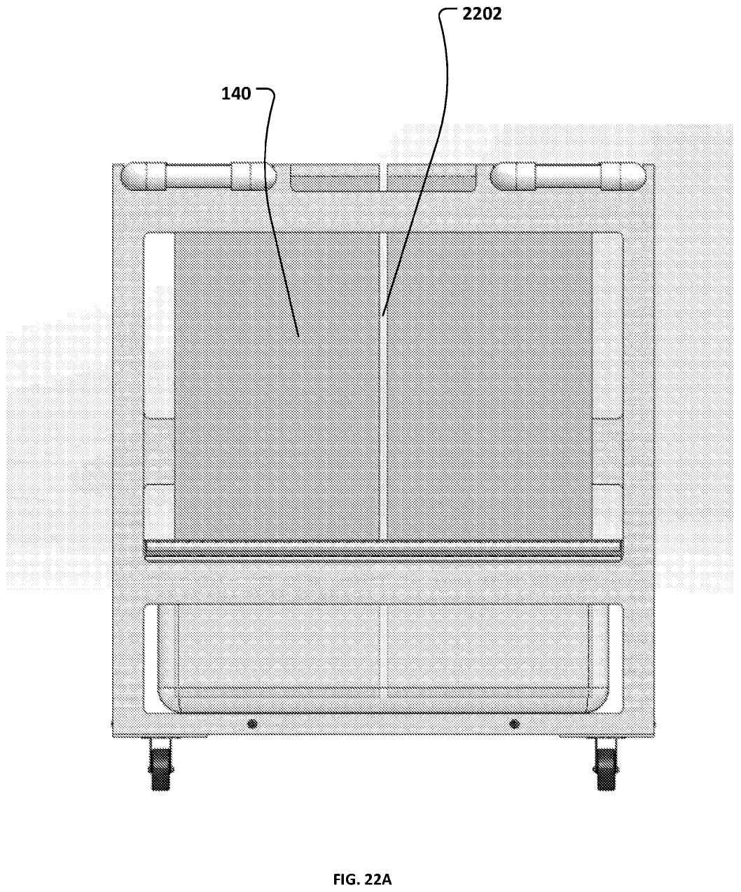

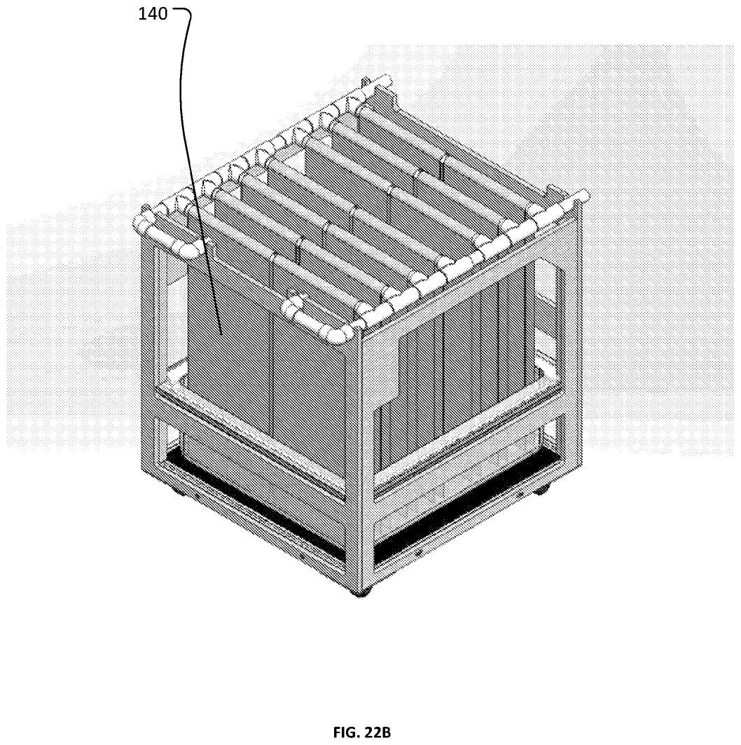

In some embodiments, the evaporative condition may comprise a relationship between osmolarity of the collected media, temperature of the collected media, and/or humidity of an atmosphere in the containment structure, as conceptually illustrated in FIG. 12. For a non-limiting example, a CPU 120 may determine that the temperature status of an internal atmosphere in combination with the humidity status of an internal atmosphere warrants the adjustment of a fan speed. In such an example, the independent status of the temperature or the independent status of the humidity may each, on their own, not warrant such an adjustment of fan speed. However, each factor in combination with the other, may warrant such a fan speed adjustment. Such multi-factor logic-based operation may also extend to various other elements and functions of other example embodiments.

In some embodiments, the at least one output element may be a fan 170, a heater 180, a vent 190, or an element configured to adjust a contact surface area between the at least one evaporative layer and/or wicking layer with the moisture-containing media. In some embodiments, the output elements may be configured to operate in direct contact with a wet mass, and/or an internal containment structure or collection vessel. In some such embodiments, a collection vessel may be formed by one or a combination of an evaporative layer, a wicking layer, or a structural polymer. In non-limiting example embodiments including a fan, the fan 170 may be positioned in or on various locations of the containment structure and may be in connection with one or more apertures formed by the containment structure. The fan 170 may be configured to direct an airflow directly into the containment structure and/or direct an airflow away from the containment structure to pull air out of the containment structure. For some embodiments, the term fan may include a blower or a turbine.

In an example embodiment, the fan 170 is a pulse width modulation (“PWM”) fan. PWM fans can alter their speed and airflow. The energy and speed of the fan can be varied based on the system conditions.

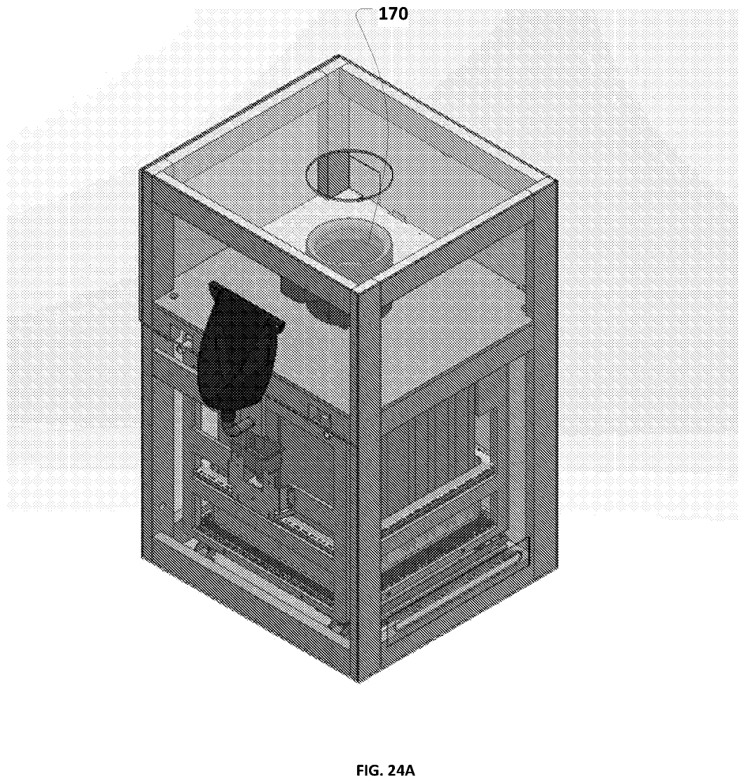

In an example embodiment, shown in FIGS. 23A-B, a hood 2300 can attach to the fan 170. The hood 2300 may collect condensation from the system, preventing it from re-entering the containment structure. The hood 2300 may include at least one channel 2302 . . . . The at least one channel 2302 may empty the condensation from the hood into a drain out of the system or into a condensation collection bag.

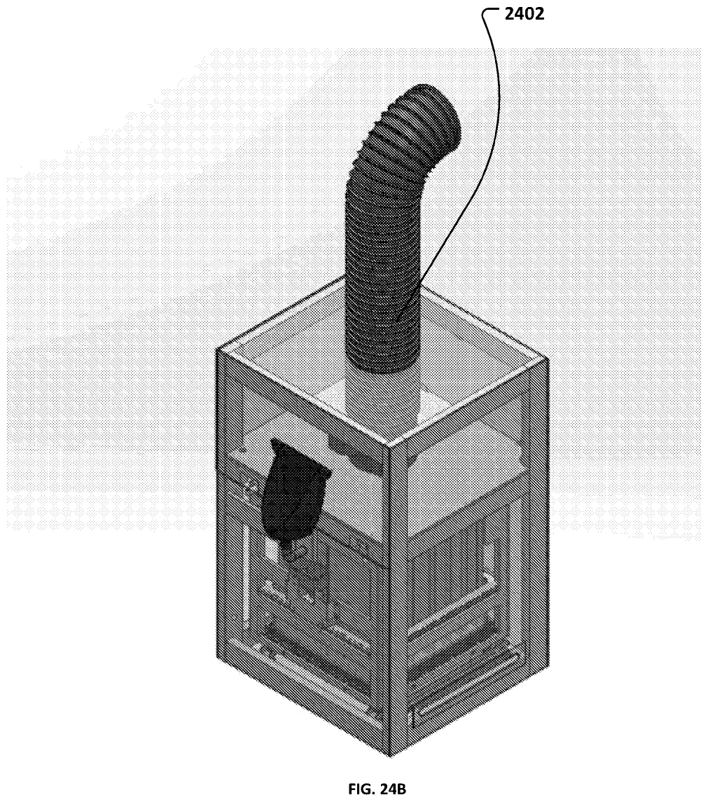

In an example embodiment shown in FIGS. 24A-B, the fan 170 is a central inline exhaust fan, which may draw air upwards, out of the containment structure. The inline fan may be connected to ducting 2402 to prevent the reintroduction of expelled moisture and/or for control odor.

In embodiments including a heater 180, the heater may supply thermal energy to the internal atmosphere and/or a contained moisture-containing media and/or an internal containment structure or collection vessel. Non-limiting examples of such a heater include a combustion heater, an electrical heater, a biochemical heater, or a conductive heater. The heater 180 may be statically or tunably positioned in various locations within the containment structure, and in various orientations relative to the moisture-containing media. In embodiments including a surface area adjustment element, the at least one evaporative layer and/or wicking layer may be raised, lowered, stretched, and/or laterally shifted to increase or decrease a contact surface area with collected media. A non-limiting example of such an element includes a gear system 303 connected to support structures 304 holding the evaporative layer and/or wicking layer, such that when the gear system is actuated, the vertical position relative to the collected media is increased or decreased. An additional non-limiting example of such an element includes a mechanical manipulator structure such that the evaporative layer is encouraged into an adjusted contact orientation with the media by the manipulator. In another example embodiment, mechanical or electromechanical elements may move, combine or separate the evaporative layers and/or wicking layers to affect airflow pathways, contact with the moisture-containing media, and/or evaporative efficiency.

In an example embodiment, the heater 180 may be partially or fully in contact with a moisture-containing media and/or an internal containment structure or collection vessel. Such configurations may increase thermal energy transfer efficiency between the heater and the media as well as reduce complexity in optimizing the positioning of the heater within the containment structure.

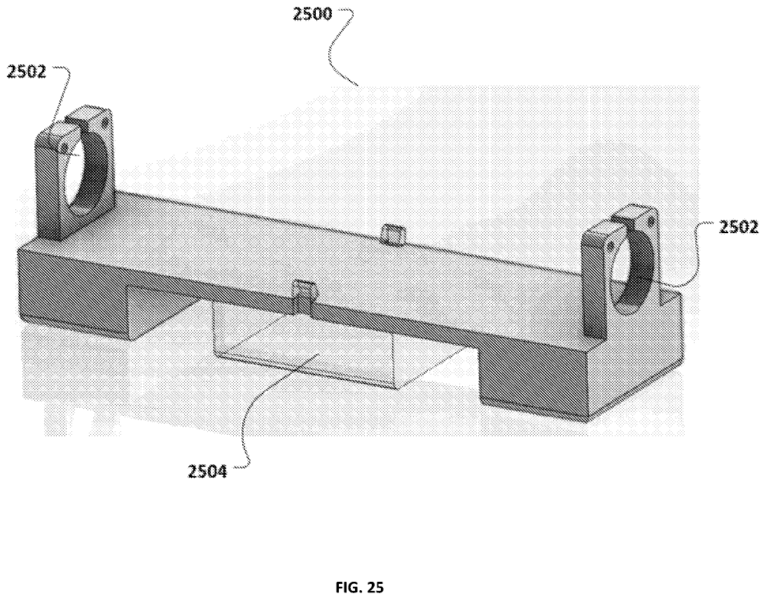

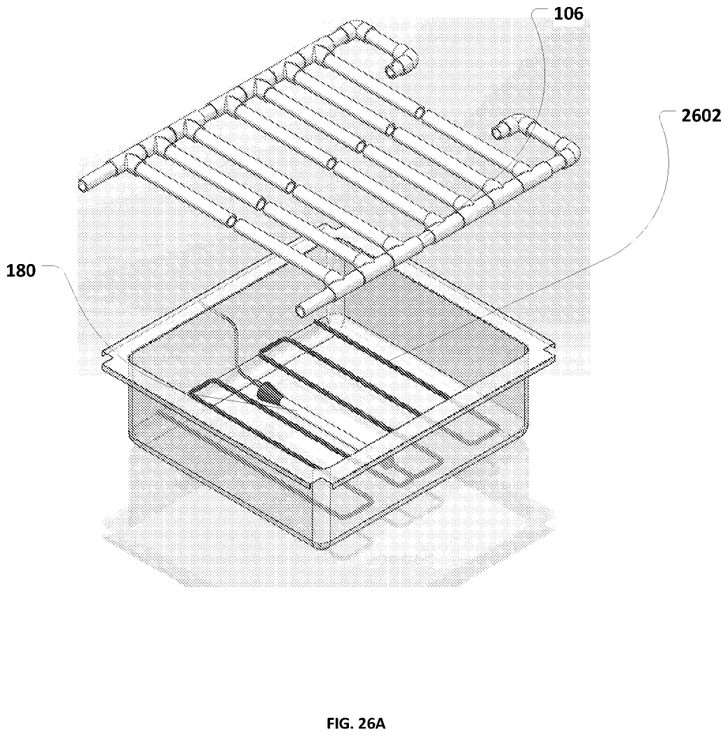

In another example embodiment, the heater 180 may be submerged in a moisture-containing media, such that it remains on or near a surface of the moisture-containing media. As shown in FIG. 25, an adjustable floatation module 2500 may be attached to the heater 180 to adjust the heater height. The floatation module 2500 may include apertures 2502 and at least one compartment 2504. In embodiments, the apertures 2502 are shaped to fit the heater 180, such that the floatation module 2500 hangs on the heater 180. The at least one compartment 2504 may be detachable. In some embodiments, the compartment 2504 may use a snap fit mechanism to attach and detach the compartment 2504 from the floatation module 2500. In embodiments with more than one compartment 2504, the additional compartments 2504 may attach in series to one another.

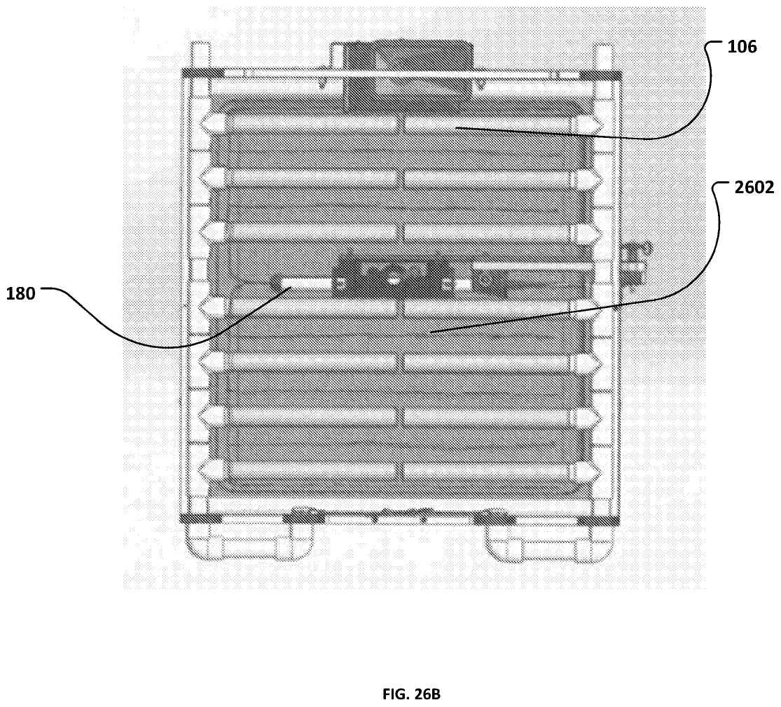

In a further example embodiment, shown in FIGS. 26A-B, an array of conductive wires 2602 are configured to carry heat from the heater 180 between the flaps of the at least one wicking layer with a split. The conductive wire may run between the rows of flaps. In this embodiment, the height of the heater 180 may remain fixed deeper in the moisture-containing media and the array of conductive wires 2602 may float above the heater 180. The height of the array of conductive wires would adjust with the height of the moisture-containing media. The conductive wires may facilitate distribution of heat more evenly across the surface and/or volume of the moisture containing media.

In some embodiments, the at least one output element is a vent 190 connecting the internal and external atmospheres and operably connected to the CPU 120 and/or an energy source 130. Such a vent 190 may be positioned in various locations on the containment structure 110 such as but not limited to a vertical side, a horizontal side, or coextensive or aligned with a profile of the containment structure. In one non-limiting example, a vent 190 may be tunable with the use of an electrically or mechanically manipulated shutter. In the event the CPU 120 determines that airflow ingress should be adjusted, it may send a command to the vent 190 to either decrease a shutter overlap with a vent opening, thereby increasing air flow ingress, or, increase a shutter overlap with a vent opening, thereby decreasing airflow ingress. A vent may further completely close a shutter to prevent air flow ingress entirely.

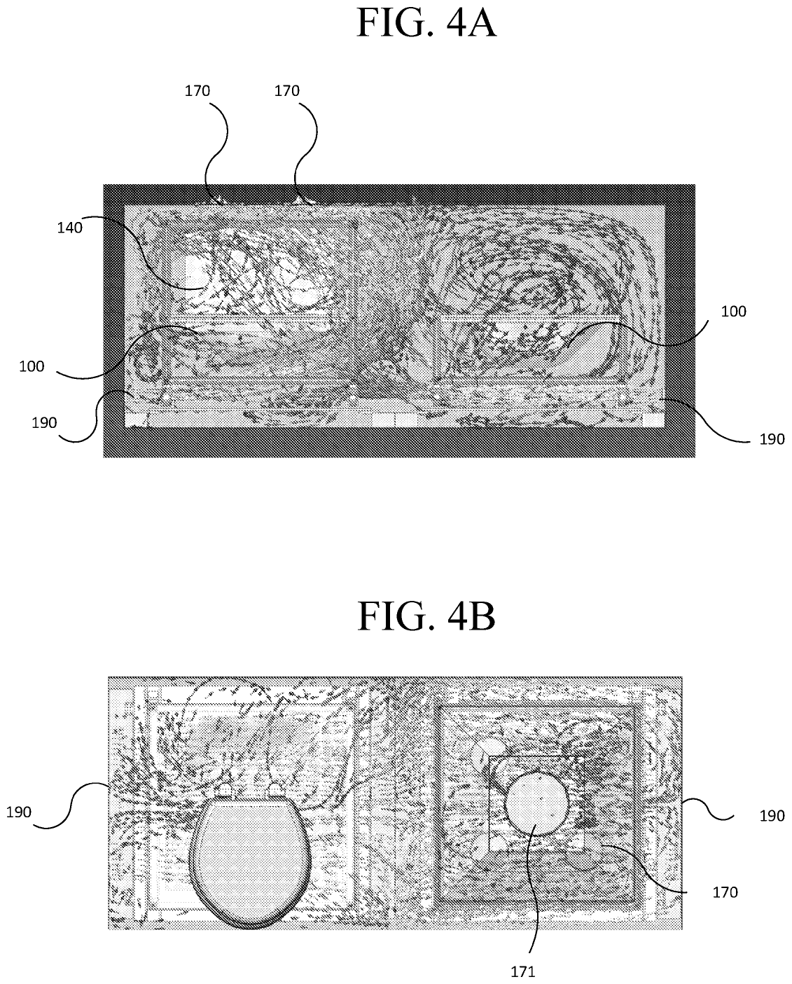

As seen in FIGS. 4A-B, Vents 190 may be configured to create optimized air flow velocities relative to at least one evaporative layer 100. Vents 190 may be positioned in specific locations on the containment structure 110 to create airflows of specific direction, speed, and fluid flow profile to create conditions beneficial to evaporative and/or pervaporative moisture or liquid removal and/or system performance and/or efficiency. In a non-limiting example, a vent 190 may be positioned to create an airflow which impinges on an evaporative layer 100 and/or a wet mass collected by the evaporative layer, thus increasing a rate of moisture evaporation from the wet mass. In another non-limiting example, a vent 190 may be positioned to create an airflow running parallel through an array of suspended wicking layers 140 not in contact with an evaporative layer 100, thus increasing the rate of evaporation of moisture contained in the wicking layers 140.

In some embodiments, an airflow baffle 191 is included. In such embodiments, the baffle 191 may be positioned within the containment structure 110 to affect an airflow within the containment structure 110. As airflows within the containment structure 110 may have a beneficial effect on evaporation and/or pervaporation of moisture or liquid, a baffle 191 may be oriented to direct said airflows into beneficial proximity with evaporative and/or pervaporative surfaces within the containment structure. In a non-limiting example, a baffle 191 may be located between a first 501 and second 502 evaporative layer. As airflows created by a vent 190 and in a directed pathway with the first evaporative layer 501 depart from the first evaporative layer, a baffle 191 may redirect the airflow into a directed pathway with the second evaporative layer 502, thus creating the same or similar evaporatively beneficial air flow trajectory with the second evaporative layer 502 as the first evaporative layer 501 and increasing the overall moisture or liquid removal performance of the embodiment.

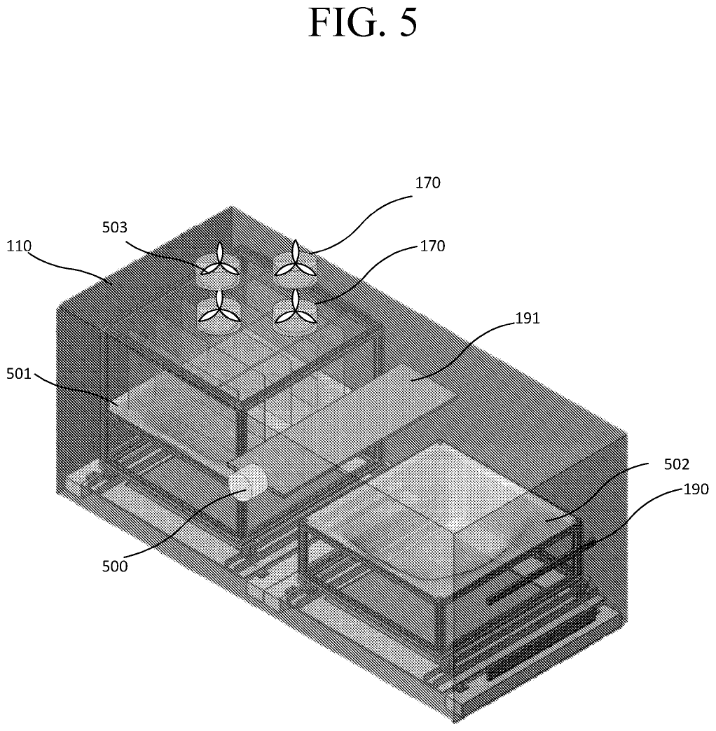

In some embodiments as seen in FIG. 5, an airflow baffle 191 may be a tunable output element. In such an embodiment, the baffle may be operably connected with the CPU 120 and/or an energy source 130. In a non-limiting example, the CPU 120 may determine that an internal airflow should be modified. The CPU 120 may send a command to the baffle 191 and, using an electrical servo 500, the baffle may change orientation to affect the internal airflow. In such embodiments, the baffle 191 may grant additional dynamic control of evaporative and/or pervaporative conditions within the containment structure 110.

In embodiments, the airflow may be between 0-4000 air changes per hour (ACH). In some embodiments, the apparatus may have a high air flow to maximize the evaporation rate in different operational and/or environmental conditions. Preferably, the airflow may be between 500-2000 ACH. In some circumstances the airflow may be lower, for example 0 ACH, indicating passive evaporation. In other circumstances the airflow may be higher. Additional ranges of airflow based on various operating conditions may be 500-600 ACH, 600-700 ACH, 700-800 ACH, 800-900 ACH, 900-1000 ACH, 1000-1100 ACH, 1100-1200 ACH, 1200-1300 ACH, 1300-1400 ACH, 1400-1500 ACH, 1500-1600 ACH, 1600-1700 ACH, 1700-1800 ACH, 1800-1900 ACH, 1900-2000 ACH. The airflow may be varied based on internal parameters (i.e., volume of liquids, usage states, etc.) and external parameters (i.e., temperatures, relative humidity, etc.). In further embodiments, the airflow may vary based on the volume of the containment structure.

In some embodiments, the at least one output may be a dehumidifier, chiller, condenser and/or Peltier device may be used to actively pull moisture from the air, facilitating more efficient evaporation of the moisture containing media.

Some embodiments may utilize or be connected to one or more input elements. Input elements may include (but are not limited to) data or devices related to; atmospheric monitoring, environmental monitoring, external, internal, or general operational monitoring; operator-defined conditions input; and received command(s) and/or remote controls or monitors and/or other communications.

In some embodiments, an output element action (such as tuning of adjustable elements and/or communicating one or more aspects of the system operations) may be effected in response to measurements or data or commands from one or more directly or indirectly operably connected input elements. Such embodiments may include a CPU, controller or microcontroller, processing unit, computing device or data analysis element that is operably connected (including but not limited to, physically, electrically, wirelessly or remotely) to the one or more output elements.

In some embodiments, the at least one input element may be operably connected to the CPU 120 such that data, information, and/or commands may be passed between the CPU 120 and the input element. The input element may be connected to one or more energy sources in various configurations, including but not limited to direct connection or indirect connection through an intermediary component.

In some embodiments, the input element may be one or a combination of a digital sensor, an analog sensor, or a sensor directly or indirectly connected to the at least one energy source. Digital sensors may include an electrical sensor utilizing a non-continuous electrical signal. A non-limiting example of a digital sensor may be a float sensor, which would act as an on/off switch contingent upon a defined or target level of collected wet mass. Analog sensors may include an electrical sensor utilizing a continuous electrical signal. A non-limiting example of an analog sensor may be a temperature sensor or a humidity sensor.

In some embodiments, the at least one input element may be a mechanical device. In a non-limiting example, a mechanical device input element may include a lid lever 200, such that the lid lever 200 is connected to the CPU 120 and when activated, such as opened or closed by a user of the apparatus, prompts the CPU 120 to send a command to another connected element, such as a lock or light.

In some embodiments, the at least one input element may be one or a combination of remote command terminal or a remote independent data source. In a non-limiting example of a remote command terminal input element, a command device wirelessly connected to the communication element 193 may send commands to the CPU 120 from a remote location. In a non-limiting example, a remote independent data source such as a weather database, may be an input element such that weather data for a specific geographic location of the containment structure at a certain time may be used by the CPU 120 to effect an output element action.

In some embodiments, at least one input element may be configured to measure atmospheric conditions inside the containment structure and/or external to the containment structure. A non-limiting example of such an element includes a thermometer 192 positioned inside the containment structure. Other non-limiting examples include a barometer, a hygrometer, an anemometer, an electrochemical or gas sensor, an infrared sensor, an ultraviolet sensor or any other atmospheric measurement sensor.

In some embodiments, at least one input element may be configured to measure a temperature of a moisture-containing media. The temperature of moisture-containing media may vary based on factors including temperature of an external atmosphere, temperature of an atmosphere internal to the containment structure, the duration of time the media has been contained in the structure, as well as other factors. In some embodiments, it may be beneficial to monitor the temperature of a moisture-containing media. Non-limiting examples of such temperature-measuring input elements include a contact thermometer in contact with the moisture-containing media and an infrared thermometer set a distance from the media.

In some embodiments, the at least one input element may be configured to measure one or a combination of an osmolarity, osmolality, or chemical and/or biological constituency of the moisture-containing media. In such an embodiment, the input element may be in direct contact with the media, or may be at some operably proximate distance to allow accurate measurement of the media.

Non-limiting examples of input elements in some such embodiments include a total dissolved solids sensor, an ion sensor, a conductivity sensor, a pH sensor, a colorimetric sensor, a salinity sensor, an electrochemical sensor, or any sensor capable of measuring osmolarity and/or osmolality.

In some embodiments, the at least one input element may be configured to detect or measure the presence of a bacteria, virus, fungus, microorganism, or a biological material or biological indicators. Such input elements may detect organisms themselves, biochemicals or fragments of organisms, metabolites or other chemicals secreted by biological organisms, or biological activity of organisms. Such input elements may communicate results or measurements to the system's CPU 120, and as a result, may trigger one or a number of responses, including (but not limited to): data transmission to a remote operator, data collection and/or transmission to elucidate or track epidemiological trends, disinfection or other removal of such biological materials, or an onboard system warning. Non-limiting examples of such sensors include: optical density measurements or sensors; optical detection methods or sensors including (but not limited to) luminescence, fluorescence, reflectance and absorbance; staining or colorimetric indicators; chemical or biochemical analysis of sedimented or precipitated matter; selective binding techniques or sensors; microfluidics, nanofluidics and/or cytometric analysis methods or devices; enzyme-based biosensors; immunosensors; nucleic acid biosensors; thermal biosensors; piezoelectric biosensors; electrochemical biosensors; optical biosensors; and molecular probes including but not limited to fluoroprobes and immunoprobes.

In some embodiments, the at least one input element may be configured to detect or measure the containment capacity of the evaporative layer. Such elements may communicate results or measures to the system's CPU 120, and as a result, may trigger an alarm in the following non-limiting circumstances: when the evaporative layer is at a maximum containment capacity (e.g., indicating that the evaporative layer may overflow), when there is a sudden drop in weight and/or volume (e.g., indicating that there may be a leak in the evaporative layer), and when there is a sudden increase in weight and/or volume (e.g., indicating that someone is using the apparatus). Non-limiting examples of such sensors include: glass level gauges, floats, displacers, bubblers, differential pressure transmitters, load cells (i.e., strain gauge devices), magnetic level gauges, magnetostrictive level transmitters, ultrasonic level transmitters, laser level transmitters, infrared laser transmitter and radar level transmitters.

In some embodiments, the at least one input element may be configured to detect when the apparatus is being used by a user. As a non-limiting example, the input element may detect if there is weight on a seat of the containment structure configured to support the weight of the user. As another non-limiting example, the input element may detect if the seat is in an open position. As yet another non-limiting example, the input element may detect if a door to a space that contains the apparatus is locked. Such elements may communicate results or measures to the system's CPU 120, and as a result, may trigger a user mode, where the comfort of the user is prioritized. For example, the comfort of the user may be prioritized by lowering the airflow of the system or implementing noise reduction protocols, such as turning off the fan or ventilation systems.

In some embodiments, the CPU 120 may be configured to control one or more output elements based on an input from one or more input elements. For a non-limiting example, the CPU 120 may receive an internal air temperature or humidity measurement from an input sensor, and, based on such a reading, open or close a vent.

In one example embodiment, the CPU 120 may be configured to control one or more output elements based on at least one input element detecting that a user is utilizing the apparatus. For this non-limiting example, the CPU 120 may turn and/or reduce the power to one or more output elements to prioritize the comfort of the user.

The CPU 120 may communicate with a remote terminal based on a data value or measurement collected from one or more input elements. The CPU 120 may utilize a communication element 193 to send and/or receive communications with such a remote terminal. For a non-limiting example, the CPU 120 may receive a weight of collected wet mass measurement from a connected load cell, and using a communication element 193, send the load measurement to a remote, centralized terminal where said data is aggregated between multiple sister embodiments in communication with the terminal. The terminal may then communicate a message to the CPU 120 to control an output element, such as activating an indicator element 201 indicative of an operative status of the embodiment.

In some embodiments, communication elements 193 may be configured to transmit and/or receive data, messages, and/or commands via wifi, Bluetooth, radio, cellular wireless networks, global positioning systems, or any other wireless connection systems. Such communication elements 193 may be connected to the CPU 120 and/or an energy source 130. Non-limiting examples of such communication elements 193 include a discrete antenna positioned in, on or adjacent to the containment structure and/or an integral antenna 603 housed within or adjacent to an electrical component such as a controller board.

In some embodiments, the CPU 120 may include a control system. The control system may be an on-board system (i.e., a microcontroller analyzes and makes changes to the system on its own) or a remote system (i.e., a person or server analyzes the data and sends back a command).

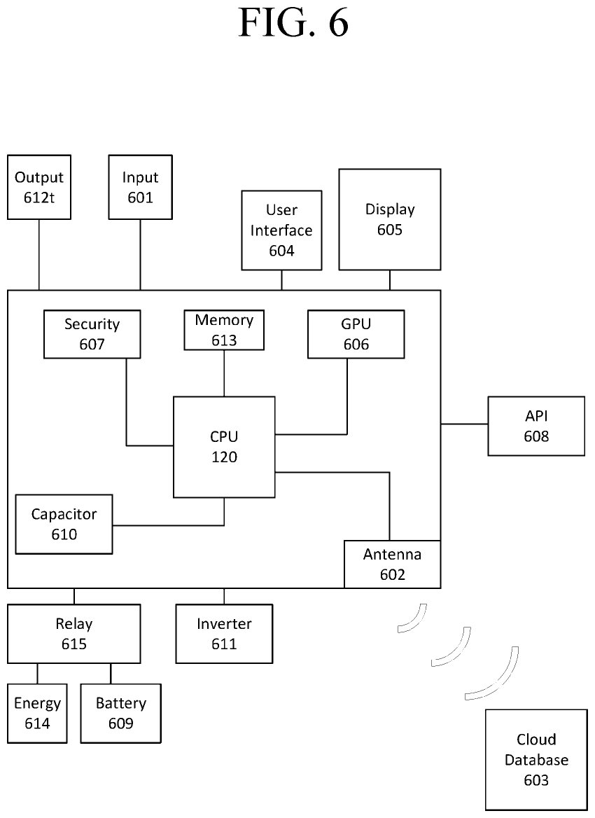

In some embodiments as shown in FIG. 6, the CPU 120 may connect to one or more electrical components and/or devices. Embodiments may include various configurations of both type and quantity of such elements, with non-limiting examples including input elements including but not limited to sensors 601, communications receivers and/or antennae 602, local 613 and/or cloud-based memory or data storage 603, a user interface 604, a display 605, a graphics processing unit 606, a security module 607, an application programing interface 608, a battery 609, a second energy source 614, a capacitor 610, an inverter 611, output elements 612 including but not limited to electrical effectors and/or actuators, electromechanical devices or components, mechatronic devices or components, or a relays 615. In some embodiments, the electrical components may be directly connected to the CPU 120. In other embodiments, electrical components may be indirectly or wirelessly connected to the CPU 120.

In some embodiments, the at least one input element may be a load cell 194 configured to measure the weight of a moisture-containing media. As the mass and/or volume of collected moisture-containing media increases over time as an embodiment is in use in the field, there may be situations in which the weight and/or mass-related volume of the media approaches or reaches a threshold beyond which an embodiment may effectively or safely operate. Input element(s) configured to measure the weight may provide insights into the operating capacity or performance of the embodiment, such that when a maximum or minimum weight is measured, a signal, measurement or communication may be generated to indicate a maximum or minimum weight has been reached. Alternatively, in some embodiments, a sudden measurement drop may indicate a catastrophic failure of the embodiment resulting in a loss of containment of the media. In other embodiments, incremental increases in measured weight may be used to tabulate a quantity of media deposits into the containment structure. Non-limiting examples of other load input elements may include a digital load sensor, an analog load sensor, a piezoelectric sensor, or any other sensor capable of measuring or detecting a weight.

In some embodiments, the input element may be configured to detect a presence of a user of the apparatus. It may be beneficial or useful to monitor when a user is actively depositing media into the containment structure for at least privacy, safety, and operation efficiency purposes. Such user detection input elements may be positioned on the containment structure's exterior, interior, or adjacent to the containment structure. For a non-limiting example, a detected user may result in the CPU 120 tabulating a user count such that a running total of users of the embodiment may be stored or communicated to another element. In another non-limiting example, a detected user may result in the CPU 120 activating a visual indicator, thus indicating that a user is using the embodiment.

Non-limiting examples of such an input element include but are not limited to a laser sensor, an ultraviolet sensor, a photoelectric sensor, a motion sensor, a proximity sensor, a sensor to detect sound, a pressure sensor, a touch or contact sensor, an infrared sensor, an ultrasonic sensor, or any other sensor capable of detecting a user presence.

In some embodiments, the at least one input element may be configured to measure a distance of a moisture-containing media or wet mass relative to a location or reference point within the embodiment. Similar to a weight of collected media potentially reaching a critical maximum or minimum level, the volume of collected media may also reach a critical maximum or minimum level preventing the embodiment from operating safely, optimally and/or efficiently. It may thus be beneficial to measure and/or monitor the volume of a collected media periodically or continuously. One non-limiting example approach to volume measurement may be to measure the distance between a stationary, internal location of the embodiment and an outer surface of a volume of a collected media. As the distance decreases, it can be understood that the media volume is increasing. Such an input element may be positioned inside the containment structure 110 at a location of operable distance and perspective with a contained media. Non-limiting examples of such an input element include but are not limited to a laser sensor, an infrared sensor, an ultraviolet sensor, an ultrasonic sensor, a photoelectric sensor or any other sensor capable of measuring distance.

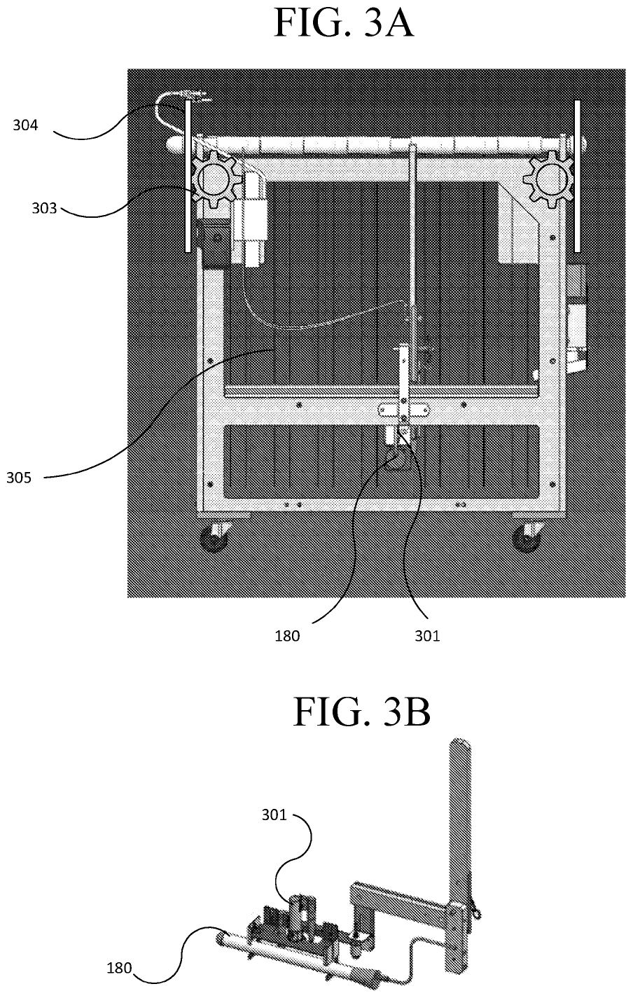

In other embodiments as seen in FIG. 3., the amount, volume, or containment level of collected moisture-containing media may be measured or detected by a float sensor 301 configured to measure a level of collected moisture-containing media. Some alternative embodiments may employ a float switch (eg mechanical, electrical, or magnetic) which opens or closes a circuit as the level of a liquid within in a containment vessel rises or falls in relation to a set level or height. Such an opening or closing of this circuit will send an on or off signal to the CPU 120, which in turn may use this signal to turn on or off, trigger or adjust an output element. In some embodiments, the float sensor 301 may include at least one stationary reference sensor configured to detect or measure the location of a movable float element in physical interaction with a collected media. In other embodiments, a float sensor may include one or more contact sensors configured to indicate a level of collected media such as for non-limiting example, when a media reaches and contacts a known height of a contact sensor, a CPU 120 may understand that media is at the height of the contact sensor. In a non-limiting example, a float sensor 301 housed in an internal containment structure or collection vessel and may physically interact with collected media, and signal to the CPU 120 when the collected wet mass is approaching a level where it could overflow. The CPU 120 may then signal or communicate one or several warnings to avoid the system overflowing, including but not limited to a warning indicator light 201 or beeping sound to signal to users that the apparatus is nearing full capacity; a locking latch or mechanism to seal or block off the system from further use; or an alert transmission to a remote operator to warn them that the system is approaching full capacity and in need of servicing.

In some embodiments, the at least one input element may be configured to measure a moisture content of the moisture-containing media and/or at least one evaporative layer 100. Input elements of such an embodiment may be in direct contact with the moisture-containing media and/or evaporative layer 100, or may be separate from the moisture-containing media and/or evaporative layer 100. Non-limiting examples of such an element include a paper and/or textile moisture sensor, surface moisture sensor, pin-type moisture meter, pin-less moisture meter, capacitive moisture sensor, and a hygrometer.

Some embodiments may further include an external sensor operably connected to the CPU 120 and configured to measure a condition of the atmosphere external to the embodiment. In such an embodiment, the CPU 120 may be configured to control the at least one output element based on measurements and/or data from an input element and/or the external sensor. In a non-limiting example, a CPU 120 may receive data regarding external atmosphere humidity and/or temperature levels from one or a combination of input elements including sensors and/or communications from a regional weather database. If such data would indicate conditions that would hinder or slow down the embodiment's rate of moisture or liquid removal from the collected wet mass, the CPU 120 may use such inputs to adjust the embodiment's output element configuration and/or performance to result in increased moisture or liquid removal efficiency. As a non-limiting example of this adjustment, the CPU 120 may take such humidity and/or temperature inputs, and process these data using a static or dynamic algorithm, or compare these data with a single or multi-dimensional look-up table (static or dynamic) or other processing approaches. Based on such processes, the CPU 120 may tune or adjust one or more output elements. In another non-limiting example, the CPU 120 may transmit or communicate data or a message based on such processes to a remote operator or terminal. In another non-limiting example, based on humidity and/or temperature inputs from one or more input elements and/or external sensor, the CPU 120 may use such data to determine that the embodiment requires increased air flow to optimize its evaporative efficiency or moisture or liquid removal rates. As a result, the CPU 120 may increase the number of internal fans operating or increase the speed of such fans (for example, varying air flow between 85 cubic feet per meter and 1000 cubic feet per meter), or it may send a message to a remote operator that the system requires some servicing.

In another non-limiting example, the embodiment may measure external environmental humidity of above 95%. As a result, the CPU 120 may tune heater elements to increase the internal atmosphere or media temperature to a target range of 90-95 degrees Fahrenheit. In another non-limiting example, the embodiment may measure external environmental temperature to be cooler than an optimal target operating temperature. As a result, the CPU 120 may tune internal heater elements to increase the internal atmosphere or media temperature to a target of 1-10 degrees Fahrenheit above the external temperature.

In another example embodiment, the CPU 120 may determine or calculate that a sensor measurement is above or below a target value. Based on the difference between actual and target values, the CPU 120 may adjust an output element to minimize or eliminate the calculated difference between actual and target values. Such target values may be included in an internal memory and/or may be queried or communicated from a remote data source or operator. In a non-limiting example, a CPU 120 may receive a thermometer measurement that an internal atmosphere temperature is 100 degrees Fahrenheit. The CPU 120 may calculate that the measured temperature is 20 degrees lower than a target atmosphere temperature as stored in an internal database. The CPU 120 may then activate a heater to increase the internal temperature to reduce the difference between target and actual temperatures. The CPU 120 may periodically or continually make such calculations and/or adjustments.

Some example embodiments may include an indicator element 201 operably connected to the CPU 120 and/or the at least one energy source 130. It may be beneficial for some embodiments to have the ability to indicate a status of the embodiment such as, but not limited to, the reaching of a maximum media containment capacity or the malfunction of an internal component. In a non-limiting example, a CPU 120 may determine that the embodiment is no longer suitable for additional moisture-containing media and activates an indicator element to signal that the embodiment is no longer available for use.

Non-limiting examples of indicator elements include one or a combination of a light, a speaker, a screen, a communication, an electrical indicia, or a mechanical indicia. Such example elements may be attached to an embodiment in various configurations including on the exterior and of the containment structure and/or associated structures proximate to an embodiment. Operable connections of an indicator may include wired or wireless connection.

In some embodiments, the CPU 120 may be configured to activate an indicator element 201 when a sensor measurement or received data input is determined to be within a calibration range. It may be important for embodiments utilizing a sensor to both ensure said sensors are calibrated for measurement accuracy and create a calibration procedure that can be easily performed in the field. For a non-limiting example, a maintenance personnel may engage in a calibration procedure on one or more load cell sensors of an embodiment. After placing a known weight in measurement contact with the sensor and/or on a measurement surface in contact with the sensor, a CPU 120 may determine that a calibration value range associated with the known weight has been detected, and may activate an indicator such as a light or audible tone to notify the personnel of the calibration range measurement. In such an example, a calibration procedure of a sensor may be simplified or improved.

Some embodiments may include a switch or relay 615 in circuit with the at least one energy source, and a CPU 120 may be configured to selectively connect and/or disconnect the at least one energy source 609 from connection with embodiment by controlling the switch. In such embodiments, there may be a need to manage or optimize available power or energy usage, or there may be a preference to reduce power or energy consumption or to switch to an alternative energy source when and if an alternative source is available. For a non-limiting example, a CPU 120 may determine that the first energy source such as a battery is depleted and that a second energy source such as a solar panel array should be used to power connected elements. The CPU 120 may activate a switch to disconnect the depleted battery from circuit, and connect the solar array in circuit. The CPU 120 may further make determinations of the availability and/or viability of an intermittent or alternate energy source, such as the non-limiting example of determining that an operably connected solar array and/or wind turbine is ready or able (i.e. the sun is out or the wind is blowing, respectively) to supply sufficient energy if connected in circuit. Another non-limiting example function may include the use of remote data sources, such as real-time weather data, to alert the CPU 120 to availability of intermittent and/or renewable energy sources and aid the CPU 120 in determining which energy source should be switched in or out of circuit. Another non-limiting example function may include the capability of the CPU 120 to monitor energy use or power draw of different elements within the embodiment. As an extension of the previously-mentioned function, the CPU 120 may make a determination to adjust the usage or power consumption of one or more such elements, and/or possibly make determinations to balance or optimize between the usage of some elements versus other elements.

In some embodiments the CPU 120 may determine that all energy sources should be removed from circuit using a switch to preserve energy, such as but not limited scenarios when the embodiment has not been used for an extended period of time. In such an embodiment, a disconnected energy source may be reconnected when the CPU 120 determines that energy should be supplied again. In embodiments where all energy is disconnected, the CPU 120 may include a separate reserve energy source to maintain its own operation, including the ability to activate a switch, during periods that a primary energy source is disconnected from the embodiment.

In some embodiments, the CPU 120 may implement duty cycles to reduce power consumption. In one example embodiment, a mechanical implementation may be used, such as a timer that controls at least one output element (i.e., a fan, a heater or a vent). In another example embodiment, an electrical implementation may be used, such as a microcontroller or a remote operator that controls the at least one output element. Including duty cycles may allow for adjustments to operational and environmental conditions.

Some embodiments may include a first and second fan 170 in operable connection with the CPU 120 and an energy source 130. The containment structure may form one or more apertures 503 allowing air flow passage between the internal and external atmospheres. In a preferred embodiment, apertures 503 may be located directly above an evaporative layer 501 containing a wet mass, such that airflows may be directed toward or away from said layer and/or wet mass. In other embodiments, apertures 503 may be located in various locations on the containment structure 110. Fans 170 may be positioned in connection with the containment structure 110 and/or a corresponding aperture 503 such that airflow generated by a corresponding fan 170 may pass through the aperture 503. In some embodiments, the containment structure 110 may further form a circulation aperture 171 in addition to apertures 503 in connections with a fan. Such a circulation aperture 171 may aid in the circulation of air flows or currents between the internal and external atmospheres. The circulation aperture 171 may be located adjacent to fan apertures 503 or, may be located distant to the fan apertures 503 on various locations of the containment structure 110. In some embodiments, the circulation aperture 171 may be positioned coplanar with the one or more fan apertures 503.

In some embodiments, the first and second fans 170 may be configured to generate airflows with various directions relative to an evaporative layer 100. In non-limiting examples, the fans may generate flows parallel to one another, opposite to one another, or perpendicular to one another, relative to an evaporative layer 100.

In some embodiments, a chimney or exhaust stack element 172 is included. In such embodiments, the chimney 172 may aid in circulation or convection or exchange of internal and external atmospheres and may additionally provide an exhaust pathway for fumes or gasses away from a user of the embodiment. In a non-limiting example, the chimney 172 is connected to the embodiment and positioned so as to encompass one or more fans 170 and/or circulation apertures 171.

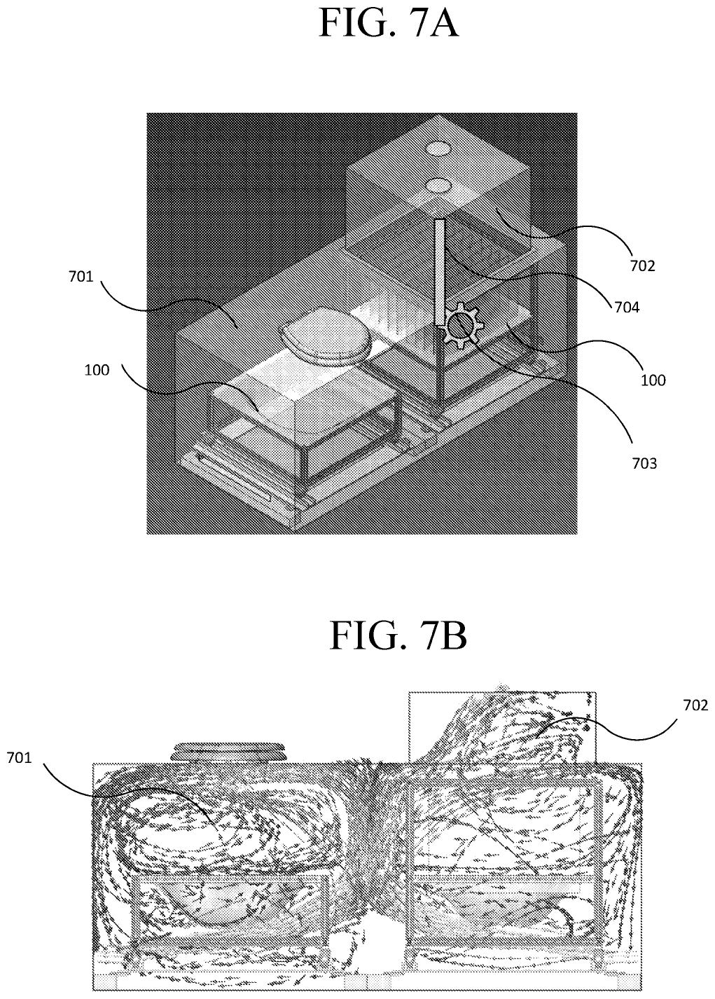

As seen in FIGS. 7A-B, in some embodiments the containment structure may form a first 701 and second 702 headspace volume positioned adjacent to the one or more evaporative layer 100. In such embodiments, the first headspace volume is larger than the second headspace volume, such that air flow trajectories within the containment structure 110 are beneficially affected to improve evaporative and/or pervaporative moisture or liquid removal performance and/or efficiency. Each headspace volume's position relative to an evaporative layer 100 may vary. In a preferred embodiment, each headspace volume is positioned adjacent to one another, and positioned directly above an evaporative layer 100. In other embodiments, headspace volumes may be positioned separately from one another, and lateral to and/or beneath an evaporative layer. In one such embodiment, one or more headspaces may be tunable by the CPU 120. In a non-limiting example, a motor may actuate a gear 703 and rail 704 system attached to the headspace, such that when the gear and rail system is actuated, the headspace extends or recedes along a rail 704 depending on the direction of the gear 703 movement, effectively increasing or decreasing the headspace volume respectively. In such an example, the containment structure 110 may be configured to allow expansion and contraction of the headspace volume(s) while still maintaining at least partial separation between internal and external atmospheres. In other non-limiting examples, an aperture or pathway connecting two headspaces may be tuned open or closed by the CPU 120 engaging a shutter or vent element.

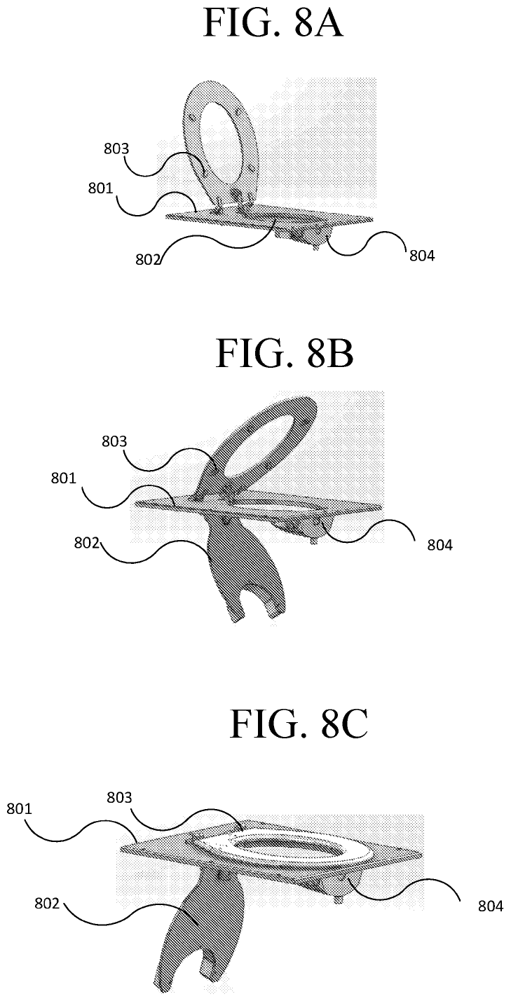

As seen in FIGS. 8A-C, in an example embodiment the containment structure 110 includes a collection opening panel 801 that also forms an orifice through which media may enter the apparatus. The collection opening panel 801 may further include a lid 802 that, when in a rest position, is configured to seal the collection opening panel 801, preventing the passage of moisture-containing media and unwanted debris, including but not limited to insects and dirt. In such an embodiment, the user may change the orientation of the lid 802 manually, allowing the passage of moisture-containing media through the collection opening panel, while the application of an external force, including but not limited to a mechanical or electrical force, causes the lid 802 to return to resting position. In some embodiments, the lid 802 may be configured to open in conjunction with one or more other moving components which may be reoriented manually by the user such as a seat 803. In a resting position, the lid 802 may also block airflow through the collection opening, preventing the passage of odors through the collection opening and/or allowing the containment structure 110 to maintain internal conditions, including but not limited to temperature, humidity, air speed and air pressure, independent of external conditions. In such an embodiment, the ability of the lid 802 to be returned to a resting position after the mechanical and/or electrical force is applied, such as by a lever connected seat 803, reduces the responsibility of the user to manually reorient the lid while allowing the containment structure to maintain such internal conditions. Non-limiting examples of the collection opening lid include plastic, fiberglass, silicone and wood.

In some embodiments, the seat 803 may include a dampening mechanism to slow down the speed of moving the seat 803 between an active orientation (i.e., when a user is using the device) or a resting orientation (i.e., when the lid 802 is in rest position). In other embodiments, the lid 802 may include a dampening mechanism to slow down the speed of moving the seat 802 between the active position (i.e., a user is using the device) and the resting position. Non-limiting examples of dampening mechanisms include dampening hinges, self-closing hinges, and padding.

In one example embodiment, the collection opening panel 801 includes a liquid diverter 804 that allows liquid media to enter the containment structure 110 and not mix with the solid moisture-containing media. In such an embodiment, the liquid diverter 804 is configured to nest within the profile of the lid 802, allowing liquid to be introduced to the containment structure 110 even when the lid 802 is closed. The availability of the liquid diverter in the closed lid configuration prevents a user from accidentally introducing liquid into the solid moisture-containing media while still allowing the user to introduce liquid into the liquid media vessel. The liquid diverter 804 may remain stationary relative to the apparatus, allowing the lid 802 to freely open or close without interference from the liquid diverter 804 and providing an input for liquid media into the containment structure 110 even when the lid 802 is in a rest position. In such an embodiment, the lid 802 may be opened to allow the addition of solid or liquid media from a user, or the lid 802 may be closed to allow the addition of liquid media through the liquid diverter 804, thus reducing the frequency of times the lid is opened and better maintaining conditions within the containment structure.

In some embodiments, the containment structure may include a seat 111 configured to support the weight of users, allowing users to sit on the apparatus without risking injury and/or damaging the apparatus. In such embodiments, the seat 111 may be ergonomic and/or conform to the user's profile, providing comfort to users while seated. In some embodiments, the seat 111 may be configured to form a hole through which moisture-containing media may enter the containment structure 110. The seat 111 may include at least one hinge and/or be configured to change orientation, allowing users to adjust and/or remove the seat 111 depending on preference. In an example embodiment, the ability of the seat 111 to support the weight of users is provided by the material from which the seat comprises. Non-limiting examples of the seat material include plastic, wood, fiberglass, aluminum and steel.

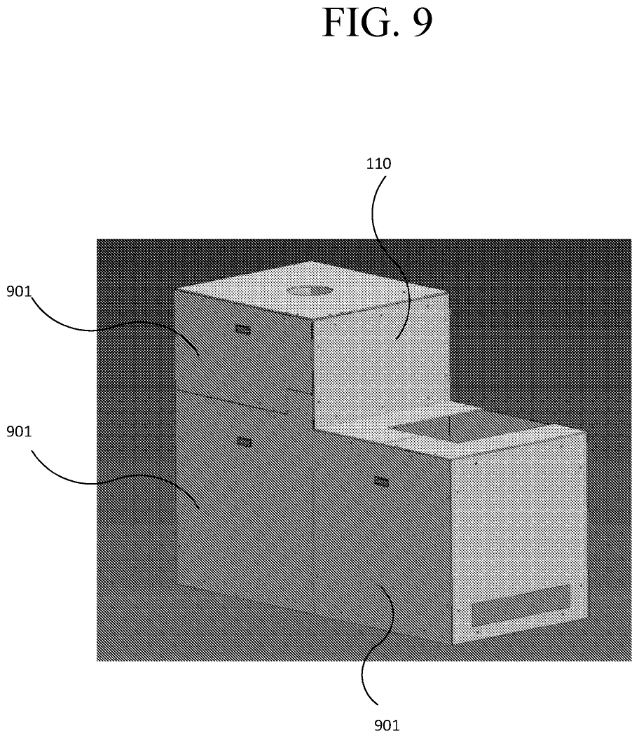

As shown in FIG. 9, in some embodiments the containment structure 110 may include one or more removable access panels 901. In such an embodiment, removable access panels 901 are configured to close or cover a containment structure opening large enough for servicers to access the inside of the apparatus and perform maintenance, including but not limited to adding, removing and/or replacing internal components. When attached to the containment structure 110, such panels may also serve a protective function in that they may prevent access to the internal space by insects or vermin, as well as providing protection from external weather conditions, and/or form a barrier to maintain separation between the external and internal conditions. Such embodiments may be designed with safety shut-off features, which may, for example, allow an operator to automatically turn off or electrically isolate all internal electrical components when a removable access panel is opened or removed for embodiment servicing. Such access panels 901, when in a closed configuration, may engage a component such as one or more interlock switches 112, where the closed panel engages such switches in the closed position to allow the operations of one or more electrical circuits. When such panels 901 are removed or opened to allow access inside the embodiment, this opens the one or more switches 112, thereby disconnecting one or more energy sources from one or more electrical circuits within the embodiment, thus shutting off connected electrical components as a safety shut-off mechanism to protect the operator, servicer and/or user during system maintenance. When such panels 901 are re-attached or placed in a closed configuration, this may re-engage the interlock switches 112 and reconnect one or more energy sources 130 to allow the one or more electrical components to operate again.

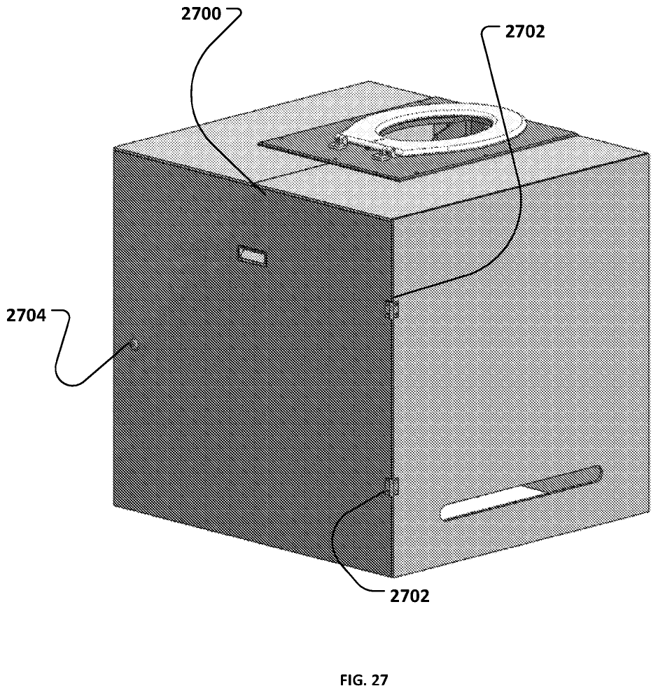

As shown in FIGS. 27, in some embodiments, panels 901 may include a servicing door 2702. Servicing door 2702 may include one or more hinges 2704 and a cam lock 2706. The cam lock 2706 may provide secure access to the containment structure for servicing.

Some embodiments may further include one or more liquid media receptacles 202 configured to collect and/or divert liquid media. Depending on configurations of some embodiments, it may be beneficial to divert and/or separate a liquid media from more solid-based moisture-containing media to optimized moisture-removal processes. A non-limiting example of such a receptacle 202 may include a funnel with tubing or piping 101 directed toward a liquid media collection vessel. Such an example receptacle may be either connected externally to the containment structure 110 or may be connected integrally.

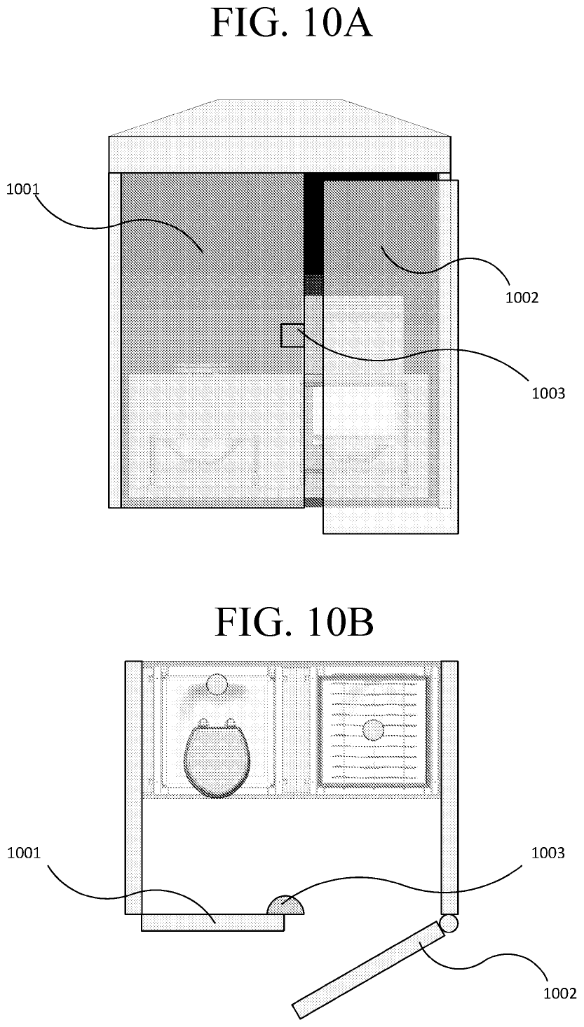

As shown in FIGS. 10A-B, some embodiments may include a user structure 1001 capable of partially or fully concealing a user of the embodiments. Such an embodiment may be useful to maintain the privacy of users and prevent others from viewing a user using the embodiment. The user structure may include a door 1002 connected to the structure 1001 and the door 1002 may include a locking mechanism 1003. In some embodiments, the locking mechanism 1003 may be an output element connected to the CPU 120 and/or the energy source 130. In a non-limiting example, an input element may signal to the CPU 120 that the system is reaching a critical capacity threshold, after which the CPU 120 may activate a lock 1003 to secure the door 1002 to prevent additional usage until the system is serviced.

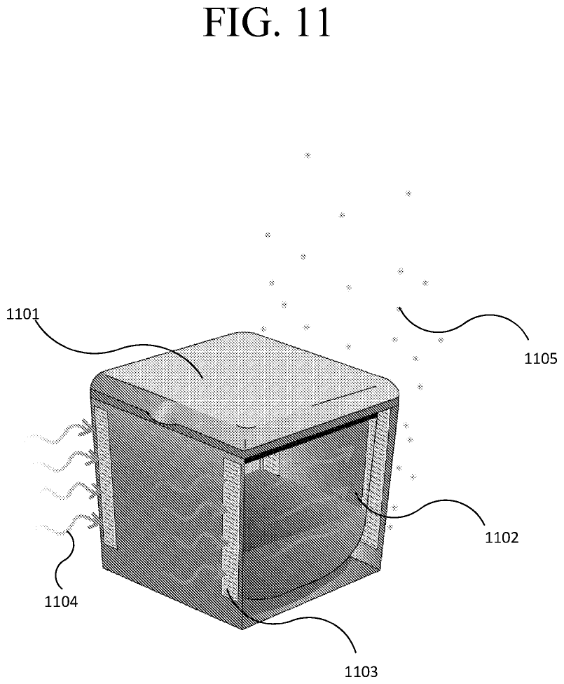

In one embodiment as seen in FIG. 11, a containment structure 1101 housing one or more evaporative layers 1102 and one or more air inlet elements 1103, such as but not limited to a vent, may be configured to be mounted on a moving vehicle. Such vehicles include but are not limited to a bicycle, automobile, passenger bus, boat, train, or airplane. In such an embodiment, vents 1103 of the embodiment may allow airflow 1104 generated from the movement of the vehicle to enter the embodiment. Such vents 1103 may be configured to direct the airflow to specific locations within the embodiment such as over a collected moisture-containing media surface and/or beneath, adjacent to, and/or impinging with an evaporative layer 1102 and/or wicking layer. In a preferred embodiment, the evaporative layer 1102 is configured with sidewalls of increased vertical height to reduce sloshing of contained media, and airflow 1104 is directed predominantly around the exterior of the evaporative layer 1102. In such a configuration, a rate of evaporative and/or pervaporative moisture or liquid removal may be increased by exploiting the movement of a vehicle and associated airflow, allowing water vapor 1105 to escape and reduce volume and weight of a collected wet mass.

### Working Examples

Working examples of various non-limiting embodiments were tested in the laboratory under test site atmospheric condition temperatures of 70-80 degrees Fahrenheit and relative humidity of 35-45%. The heating condition within the containment structure, the number of fans positioned adjacent to a liquid media, the number of fans adjacent to a solid moisture-containing media, the cubic feet per minute of directed generated fan air on a liquid media, the cubic feet per minute of directed generated fan air on a solid moisture-containing media, and the vent and/or aperture opening area were varied to simulate various non-limiting dynamic embodiment operating conditions. For some tests, atmospheric temperature and relative humidity of the test site were also varied to 88-90 degrees Fahrenheit and 94-95% humidity. The liters per day liquid and/or moisture evaporation results for such working example tests are shown in Table 1.

TABLE 1

| | | | # fans | CFMs | # fans | CFMs | Open vent | Daily |
|---|---|---|---|---|---|---|---|---|
| Test Site | | | liquid | liquid | solid | solid | (+aperture) | evaporation |
| Conditions | Test# | Heating | side | side | side | side | space (sq. in) | (L/day) |
| 70-80° F. | 1 | no | 0 | 0 | 0 | 0 | 47.5 | 1.0-1.5 |
| 35-45% RH | 2 | yes | 0 | 0 | 0 | 0 | 47.5 | 4.1 |
| | 3 | yes | 1 | 90 | 0 | 0 | 47.5 | 11.1 |
| | 4 | yes | 1 | 90 | 1 | 85 | 38.0 | 13.2 |
| | 5 | yes | 4 | 1000 | 0 | 0 | 38.0 + 50.3 | 19.3 |
| | | | | | | | (aperture) | |
| | 6 | yes | 1 | 90 | 0 | 0 | 19.5 | 12.1 |
| | 7 | yes | 1 | 90 | 0 | 0 | 39.0 | 11.1 |
| 88-90° F. | 8 | yes | 4 | 1000 | 0 | 0 | 38.0 + 50.3 | 8.7 |
| 94-95% RH | | | | | | | (aperture) | |
| | 9 | yes | 4 | 800 | 0 | 0 | 38.0 + 50.3 | 12.1 |
| | | | | | | | (aperture) | |

While particular embodiments of the present disclosure have been illustrated and described, it would be obvious to those skilled in the art that various other changes and modifications can be made without departing from the spirit and scope of the disclosure. It is therefore intended to cover in the appended claims all such changes and modifications that are within the scope of this disclosure.

What is claimed:

1. An apparatus for the removal of moisture from moisture-containing media comprising:
at least one evaporative layer configured to contact a moisture-containing media;
a containment structure configured to contain an internal atmosphere, the moisture-containing media and the at least one evaporative layer, wherein the internal atmosphere is at least partially separated from an external atmosphere;
at least one output element comprising a tunable element and/or a communication element;
a CPU operably connected to the at least one output element, wherein the CPU is configured to control the at least one output element; and
at least one energy source operably connected to the at least one output element, and/or the CPU.

2. The apparatus of claim 1, wherein the at least one evaporative layer comprises one or a combination of a hydrophilic material, a hydrophobic material, a non-hydrophobic material, a wicking and/or breathable material, an oleophobic material, or a hygroscopic material.

3. The apparatus of claim 1, wherein the at least one evaporative layer is configured to remove moisture from the moisture-containing media at least in part by pervaporation.

4. The apparatus of claim 1, further comprising at least one wicking layer.

5. The apparatus of claim 4, wherein the at least one wicking layer is not connected to the at least one evaporative layer.

6. The apparatus of claim 1, wherein the at least one output element is a fan, a heater, a vent, or an element configured to adjust a contact surface area between the at least one evaporative layer and/or wicking layer with the moisture-containing media.

7. The apparatus of claim 6, wherein the at least one output element is a heater configured to operate in contact with the moisture-containing media and/or an internal containment structure or collection vessel.

8. The apparatus of claim 1, wherein the at least one output element is a vent connecting the internal and external atmospheres.

9. The apparatus of claim 8, wherein the vent is configured to provide an airflow having an optimized velocity relative to the at least one evaporative layer.

10. The apparatus of claim 1, wherein the at least one output element is an adjustable airflow baffle configured to direct an airflow relative to the at least one evaporative layer.

11. The apparatus of any preceding claim, wherein the output element is configured to affect a rate of evaporation of moisture from the moisture-containing media.

12. The apparatus of any preceding claim, wherein the communication element is configured to transmit and/or receive data via at least one of wifi, Bluetooth, radio, cellular wireless network, global positioning system, or any other wireless connection.

13. The apparatus of any preceding claim, further comprising an electrical component and/or system operably connected to the CPU and/or the at least one energy source, wherein the electrical component and/or system is one or a combination of a local and/or cloud-based memory, an application programing interface, a user interface, a display, a graphics processing unit, a security module, a battery, a capacitor, an inverter, or a relay.

14. The apparatus of claim 1, further comprising at least one input element operably connected to the CPU.

15. The apparatus of claim 14, wherein the at least one input element is one or a combination of a digital sensor, an analog sensor, or a sensor directly or indirectly connected to the at least one energy source.

16. The apparatus of claim 14, wherein the at least one input element is a mechanical combination of a remote command terminal or a remote independent data source.

17. The apparatus of claim 14, wherein the at least one input element is a mechanical device.

18. The apparatus of claim 14, wherein the at least one input element is one or a combination of a thermometer, a barometer, a hygrometer, an anemometer, an electrochemical or gas sensor, an infrared sensor, an ultraviolet sensor or any other atmospheric measurement sensor.

19. The apparatus of claim 14, wherein the at least one input element is configured to measure one or a combination of an osmolarity, osmolality, or chemical and/or biological constituents of the moisture-containing media.

20. The apparatus of claim 19, wherein the at least one input element is a total dissolved solids sensor, an ion sensor, a conductivity sensor, a pH sensor, a colorimetric sensor, a salinity sensor, an electrochemical sensor, or any sensor capable of measuring osmolarity and/or osmolality.

21. The apparatus of claim 14, wherein the at least one input element is configured to detect a presence of a bacteria, virus, fungus, microorganism and/or other biological materials and/or indicators.

22. The apparatus of claim 14, wherein the at least one input element is configured to measure a temperature of a moisture-containing media.

23. The apparatus of claim 14, wherein the at least one input element is a load cell configured to measure a weight of a moisture-containing media.

24. The apparatus of claim 14, wherein the at least one input element is configured to detect a presence of a user of the apparatus.

25. combination of a laser sensor, an ultraviolet sensor, a photoelectric sensor, a motion sensor, a proximity sensor, a sensor to detect sound, a pressure sensor, a touch or contact sensor, an infrared sensor, an ultrasonic sensor, or any other sensor capable of detecting a user presence.

26. The apparatus of claim 14, wherein the at least one input element is configured to measure a distance of a moisture-containing media relative to a location or reference point within the apparatus.

27. The apparatus of claim 26, wherein the at least one input element is a laser sensor, an infrared sensor, an ultraviolet sensor, an ultrasonic sensor, a photoelectric sensor or any other sensor capable of measuring distance.

28. The apparatus of claim 14, wherein the at least one input element is a float sensor configured to measure a level of a collected moisture-containing media.

29. The apparatus of claim 14, wherein the at least one input element is configured to measure a moisture content of the moisture-containing media and/or at the least one evaporative layer.

30. The apparatus of claim 29, wherein the at least one input element is one or a combination of a paper and/or textile moisture sensor, surface moisture sensor, pin-type moisture meter, pin-less moisture meter, capacitive moisture sensor, or a hygrometer.

31. The apparatus of claim 14, 15, 16, 17, 18, 19, 20, 21, 22, 23, 24, 25, 26, 27, 28, 29, or 30, wherein the CPU is configured to control the at least one output element based on an input from the at least one input element.

32. The apparatus of any preceding claim, further comprising an indicator element operably connected to the CPU and/or the at least one energy source, wherein the CPU is configured to activate the indicator element.

33. The apparatus of claim 32, wherein the indicator element is one or a combination of a light, a speaker, a screen, or an electrical and/or mechanical indicia.

34. The apparatus of claim 32, wherein the CPU is configured to activate the indicator element when a sensor measurement or received data input or command is determined to be within a calibration value range.

35. The apparatus of claim 1, further comprising a switch in circuit with the energy source, wherein the CPU is configured to selectively connect and/or disconnect the energy source from operable connection with the apparatus by controlling the switch.

36. The apparatus of claim 1, further comprising a second energy source operably connected the at least one output element and/or the CPU, and further comprising a switch in circuit with the at least one and second energy source, wherein the at least one energy source comprises a first energy source, and wherein the CPU is configured to selectively connect and/or disconnect the first and/or second energy source from operable connection with the apparatus by controlling the switch.

37. The apparatus of claim 14, further comprising an external sensor operably connected to the CPU and configured to measure a condition of the external atmosphere, wherein the CPU is configured to control the at least one output element based on measurements and/or data from the input element and/or the external sensor.

38. The apparatus of claim 1, further comprising a second tunable fan and wherein the at least one output element is a first tunable fan.

39. The apparatus of claim 38, wherein the first and second tunable fans are positioned in connection to a corresponding first and second fan aperture formed by the containment structure.

40. The apparatus of claim 39, wherein the containment structure further forms a circulation aperture adjacent to the first and second fan aperture.

41. The apparatus of claim 40, wherein the circulation aperture and the fan apertures are coplanar.

42. The apparatus of claim 39, wherein the first and second fans are configured to generate air currents having different flow directions relative to the location of the at least one evaporative layer.

43. The apparatus of claim 39, wherein the first fan is configured to generate an air current perpendicular to an air current generated by the second fan.

44. The apparatus of claim 39, wherein the first fan is configured to generate an air current having an opposite direction to an air current generated by the second fan.

45. The apparatus of claim 39, wherein the first fan is configured to generate an air current having a parallel direction to an air current generated by the second fan.

46. The apparatus of any preceding claim, wherein the containment structure forms a first and second headspace volume, each volume being adjacent to the at least one evaporative layer, and wherein the first volume is greater than the second volume.

47. The apparatus of claim 1, further comprising a static airflow baffle configured to direct an airflow relative to the at least one evaporative layer.

48. The apparatus of claim 1, wherein the CPU is configured to communicate messages, commands or data to a remote terminal and/or receive messages, commands or data from a remote terminal.

49. The apparatus of claim 48, wherein the CPU is configured to communicate a message, command and/or data to a remote terminal based on a value received and/or measurement collected from an at least one input element.

50. The apparatus of claim 1, wherein the containment structure includes a collection opening panel forming an orifice for introducing moisture-containing media, and further comprising a lid configured to rest in a rest position that prevents moisture-containing media from passing through the collection opening panel, be oriented in an open position that allows moisture-containing media to pass through the collection opening panel when a mechanical and/or electrical force is applied to the lid, and return to the rest position when the mechanical and/or electrical force is removed from the lid.

51. The apparatus of claim 50, further comprising a liquid diverter configured to nest within a profile of the lid and allow liquid to be introduced into the containment structure, and remain stationary relative to the apparatus when the lid is oriented in an open position.

52. The apparatus of claim 1, wherein the containment structure includes at least one removable access panel.

53. The apparatus of claim 52, further comprising a switch that is engaged by, in contact with and/or connected to the at least one removable access panel, wherein any energy source is removed from operable connection with the apparatus when the at least one removable access panel is removed from the apparatus.

54. The apparatus of claim 1, further comprising at least one liquid media receptacle configured to collect and/or divert liquid media.

55. The apparatus of claim 1, further comprising a seat configured to support a user weight.

56. The apparatus of claim 1, further comprising a user structure configured to at least partially conceal a user when the user deposits moisture-containing media into the apparatus, and a user door attached to the user structure, wherein the output element is a locking mechanism attached to the door and/or user structure.

57. The apparatus of any preceding claim, wherein the apparatus is a toilet, the moisture-containing media is human waste, the containment structure encloses a urine collection side and a stool collection side each including an evaporative layer to evaporatively and/or pervaporatively remove moisture or liquid from urine and/or stool, and the CPU is configured to effect and/or determine an evaporative condition by controlling and/or sending communications to an output element or receiving data and/or communications from an input element, or both.

58. An apparatus for the removal of moisture from moisture-containing media comprising:
at least one evaporative layer configured to contain a moisture-containing media; at least one air inlet element; and
a containment structure containing the at least one evaporative layer and forming and/or supporting the at least one air inlet element, wherein the containment structure is configured to be mounted on a mobile vehicle and wherein the at least one air inlet element is configured to direct air generated from a vehicle in motion into a pathway adjacent to and/or in impingement with the at least one evaporative layer.

59. The apparatus of any preceding claim, wherein the apparatus is a toilet.

60. The apparatus of any preceding claim, wherein the moisture-containing media is a human waste.

61. A method of increasing a rate of evaporation of moisture from a moisture-containing media comprising:
collecting a moisture-containing media in a containment structure;
removing moisture from the moisture-containing media using an evaporative layer; adjusting a tunable element; and
increasing a rate of moisture evaporation from the moisture-containing media and/or the evaporative layer.

62. The method of claim 61, wherein the at least one evaporative layer comprises one or a combination of a hydrophilic material, a hydrophobic material, a non-hydrophobic material, a wicking and/or breathable material, an oleophobic material, or a hygroscopic material.

63. The method of claim 61, wherein adjusting a tunable element comprises at least one of changing a quantity of activated fans of a plurality of fans, adjusting a vent opening, adjusting a heater output, or adjusting a heater orientation.

64. The method of claim 61, wherein the step of adjusting a tunable element comprises increasing or decreasing at least one fan speed to generate an airflow.

65. The method of claim 64, wherein the airflow is between 85 cubic feet per minute and 1000 cubic feet per minute.

66. The method of claim 61, further comprising the step of determining an evaporative condition within and/or external to the containment structure.

67. The method of claim 66, wherein the evaporative condition comprises at least one of an air temperature, an air humidity, an air pressure, an air speed, a collected media moisture content, a collected media temperature, an evaporative layer moisture content, or a collected media osmolarity.

68. The method of claim 66, wherein the evaporative condition is a relationship between osmolarity of the collected media, temperature of the collected media, and/or humidity of an atmosphere in the containment structure.

69. The method of claim 66, wherein the evaporative condition comprises a temperature differential between collected moisture-containing media and an internal atmosphere inside the containment structure.

70. The method of claim 66, wherein the step of determining an evaporative condition comprises querying a remote database for environmental data specific to a geographic location of the containment structure.

71. The method of claim 66, further comprising calculating a difference between a measured evaporative condition and a target evaporative condition, wherein adjusting the tunable element is based on the calculated difference.

72. The method of any claim from claim 61 to claim 71, further comprising the steps of:
determining a condition of each of a plurality of energy sources;
selecting an optimized energy source supply configuration; and
engaging and/or disengaging one or a plurality of the energy sources according to the optimized energy source supply configuration.

73. A method of removing moisture from a moisture-containing media comprising:
collecting a moisture-containing media into contact with an evaporative layer;
providing an airflow adjacent to a side of the evaporative layer not in contact with the collected media;
providing an airflow adjacent to a surface of the collected media; and removing moisture from the collected media.

74. The method of claim 73, further comprising the step of drawing moisture away from the collected media and into an airflow pathway using a wicking layer not connected to the evaporative layer.

75. The method of any claim from claim 61 to claim 74, wherein moisture-containing media is human waste.

76. The apparatus of claim 6, wherein the at least one output element is a heater configured to remain submerged in a collected moisture-containing media.

77. The apparatus of claim 76, wherein the heater is further configured to remain proximate to a surface of the moisture-containing media.

78. The apparatus of claim 4, wherein the at least one wicking layer includes at least one through-thickness split extending from an edge of the wicking layer.
